(19) United States
(12) Patent Application Publication
(10) Pub. No.: US 2005/0196665 A1
(43) Pub. Date: Sep. 8, 2005

(54) Battery, battery pack, method for manufacturing the battery, and method for manufacturing the battery pack

(75) Inventors: Shintaro Shimizu, Fujisawa-shi (JP); Satoshi Yoneyama, Hiratsuka-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 11/051,096

(22) Filed: Feb. 4, 2005

(30) Foreign Application Priority Data
Feb. 23, 2004 (JP) 2004-046772

(51) Int. Cl. H01M 2/10

(52) U.S. Cl. 429/99

(57) ABSTRACT

A battery of the present invention includes a pair of cylindrical bottomed cans, a joint ring for joining open end portions of the respective bottomed cans to each other, and a power generation component including a pair of electrodes, which is accommodated in the joined bottomed cans. One of the bottomed cans is electrically connected to one of the electrodes, the other bottomed can is electrically connected to the other electrode, and a region of the joint ring that is in contact with one of the bottomed cans is electrically insulated from a region of the joint ring that is in contact with the other bottomed can. With this configuration, a battery that requires a smaller space for accommodating a power generation component is provided.

### FIELD OF THE INVENTION

The present invention relates to a battery and a battery pack integrating a plurality of batteries, as well as to methods for manufacturing the battery and the battery pack.

### BACKGROUND OF THE INVENTION

In recent years, accompanying the development of transportation equipment such as hybrid electric vehicles and electric vehicles and portable equipment such as personal computers, the roles of batteries have become increasingly important. There is fierce competition for development of equipment to be equipped with a battery, and smaller batteries capable of achieving higher output, as well as low-cost batteries, have been demanded in the market.

FIG. 25 shows an example of a conventional battery. The battery 101 shown in FIG. 25 has a so-called cylindrical shape, which has been employed in various types of batteries such as a nickel-metal hydride battery and a lithium battery. In the battery 101 shown in FIG. 25, an electrode plate group 108 including a positive electrode 103, a negative electrode 104, and a separator 105 is accommodated in a cylindrical battery case 102 together with an electrolytic solution. The upper part of the battery case 102 is sealed with a sealing plate 106 that also serves as a terminal and an electrically insulating gasket 107. The battery case 102 is sealed hermetically by, for example, fixing the sealing plate 106 to the battery case 102 by caulking with the gasket 107 interposed therebetween. The sealing plate 106 is electrically connected to the positive electrode 103 or the negative electrode 104 in the electrode plate group 108 via a tab 109.

Also, batteries whose terminal portion is different from that of the battery shown in FIG. 25 have generally been used (see JP 2000-138054 A (hereinafter referred to as “Patent Document 1”) and JP 2001-52759 A (hereinafter referred to as “Patent Document 2”), for example). Such batteries often have been used in vehicles etc. that require a relatively large battery capacity. In the battery proposed in Patent Document 1, a terminal member shaped like a male thread is disposed so as to pass through a lid and is fixed to the lid with a nut that is threaded to the terminal member. In the battery with such a configuration, a caulking process for hermetically sealing the battery case is not necessary, unlike the case of the battery shown in FIG. 25.

In some applications (e.g., for use in vehicles) where a sufficient capacity, voltage, etc. cannot be achieved by a single battery, a battery pack in which a plurality of batteries are connect in series may be used. For example, one possible way to obtain a battery pack is connecting cylindrical batteries shown in FIG. 25 in series. In this case, however, although the bottom face of a battery case of each battery is flat, the top face of the battery case has a terminal portion protruding therefrom. This makes it difficult to maintain the battery pack composed of a plurality of integrated batteries stably. On this account, fixing the adjacent batteries by welding them with a connector interposed between the bottom face of one of the adjacent batteries and the top face of the other battery has been proposed, for example, in JP 10(1998)-106533 A (hereinafter referred to as “Patent Document 3”).

However, in the battery shown in FIG. 25, because the terminal and the electrode plate group are electrically connected to each other via a tab, a space for accommodating members other than a power generation component, e.g., the tab, lead, etc., needs to be provided inside the battery, thereby decreasing the energy density of the battery.

The batteries proposed in Patent Document 1 and Patent Document 2 also need a tab for collecting current. Besides, the terminal member shaped like a male thread is disposed so as to extend into a housing. Accordingly, a space for arranging the tab and the terminal member needs to be provided inside the batteries. Moreover, in order to form a battery pack by connecting batteries shown in FIG. 25 or batteries proposed in Patent Document 1 or 2, it is necessary to use the connector and the like used in the battery pack proposed in Patent Document 3, for example. However, in the battery pack proposed in Patent Document 3, a space for disposing the connector for connecting adjacent batteries needs to be provided between the adjacent batteries, which may make the miniaturization of the battery pack difficult.

### SUMMARY OF THE INVENTION

The present invention provides a battery and a battery pack that require a smaller space for accommodating a power generation component, as well as methods for manufacturing them.

A battery according to the present invention includes: a pair of cylindrical bottomed cans; a joint ring for joining an open end portion of one of the bottomed cans to an open end portion of the other bottomed can; and a power generation component including a pair of electrodes, which is accommodated in the joined bottomed cans. In this battery, one of the bottomed cans is electrically connected to one of the electrodes, the other bottomed can is electrically connected to the other electrode, and a region of the joint ring that is in contact with one of the bottomed cans is electrically insulated from a region of the joint ring that is in contact with the other bottomed can. Note here that the “bottomed can” as used herein refers to a can that includes a bottom, a sidewall(s), and an open end, and it may be constructed of either a single piece or multiple pieces.

A battery pack according to the present invention includes a plurality of the above-described batteries according to the present invention. In this battery pack, the batteries are connected in series.

A method for manufacturing a battery according to the present invention includes the steps of: (i) joining a joint ring to an open end portion of a first bottomed can; (ii) placing an electrode plate group including a pair of electrodes in the first bottomed can; and (iii) joining an open end portion of a second bottomed can to a portion of the joint ring on a side opposite to a side joined to the first bottomed can, so that the first bottomed can and the second bottomed can are joined to each other via the joint ring. The method further includes the steps of: (a) electrically connecting the first bottomed can to one of the electrodes; and (b) electrically connecting the second bottomed can to the other electrode.

A method for manufacturing a battery pack according to the present invention is a method for manufacturing a battery pack in which a plurality of batteries are connected in series. The method includes the steps of: (x) disposing a plurality of batteries so that end faces of adjacent batteries abut against each other; and (y) connecting the adjacent batteries in series by electrically connecting the end faces to each other. In this method, the batteries are the above-described batteries according to the present invention.

### BRIEF DESCRIPTION OF THE DRAWINGS

FIG. 1 is a schematic view showing an example of a battery according to the present invention.

FIG. 2 is a sectional view of the battery shown in FIG. 1.

FIG. 3 is an enlarged view of a region II of the battery shown in FIG. 2.

FIG. 4 is a sectional view showing another example of a battery according to the present invention.

FIGS. 5A to 5D are schematic views showing examples of a current collector to be used in a battery of the present invention.

FIG. 6 is a sectional view showing still another example of a battery according to the present invention.

FIG. 7 is a sectional view showing still another example of a battery according to the present invention.

FIG. 8 is a sectional view showing still another example of a battery according to the present invention.

FIG. 9 is a sectional view showing still another example of a battery according to the present invention.

FIG. 10 is a sectional view showing still another example of a battery according to the present invention.

FIGS. 11A and 11B are enlarged sectional views of a region including a joint ring in examples of a battery according to the present invention.

FIG. 12 is a sectional view showing still another example of a battery according to the present invention.

FIG. 13 is a sectional view showing still another example of a battery according to the present invention.

FIG. 14 is a sectional view showing still another example of a battery according to the present invention.

FIG. 15 is a sectional view showing still another example of a battery according to the present invention.

FIG. 16 is a sectional view showing still another example of a battery according to the present invention.

FIG. 17 is a sectional view showing still another example of a battery according to the present invention.

FIG. 18 is a plan view showing an example of a battery pack according to the present invention.

FIG. 19 is a sectional view showing another example of a battery pack according to the present invention.

FIG. 20 is a sectional view showing still another example of a battery pack according to the present invention.

FIGS. 21A to 21F are schematic views showing examples of a plate to be used in a battery pack of the present invention.

FIG. 22 is a sectional view showing still another example of a battery pack according to the present invention.

FIGS. 23A to 23D are perspective views showing an example of a method of manufacturing a battery according to the present invention.

FIG. 24 is a perspective view showing an example of an electrode plate group to be used in the method of manufacturing a battery according to the present invention.

FIG. 25 is a schematic view showing an example of a conventional battery.

### DETAILED DESCRIPTION OF THE INVENTION

A battery according to the present invention includes: a pair of cylindrical bottomed cans; a joint ring for joining an open end portion of one of the bottomed cans to an open end portion of the other bottomed can; and a power generation component including a pair of electrodes, which is accommodated in the joined bottomed cans. One of the bottomed cans is electrically connected to one of the electrodes (e.g. a positive electrode), and the other bottomed can is electrically connected to the other electrode (e.g., a negative electrode). Furthermore, a region of the joint ring that is in contact with one of the bottomed cans is electrically insulated from a region of the joint ring that is in contact with the other bottomed can. Accordingly, it is possible to configure the battery in which the pair of bottomed cans and/or the joint ring serves as a battery case, one of the bottomed cans serves as a positive electrode, and the other bottomed can serves as a negative electrode, for example. In the battery of the present invention, any region in each of the bottomed cans can be used as a terminal portion. For example, the outer surface of the bottom of each bottomed can (i.e., the region corresponding to an end face of the battery) can be used as a terminal portion. The terminal portion refers to a portion provided for electric connection to the outside of the battery. Note here that a plurality of terminal portions may be provided.

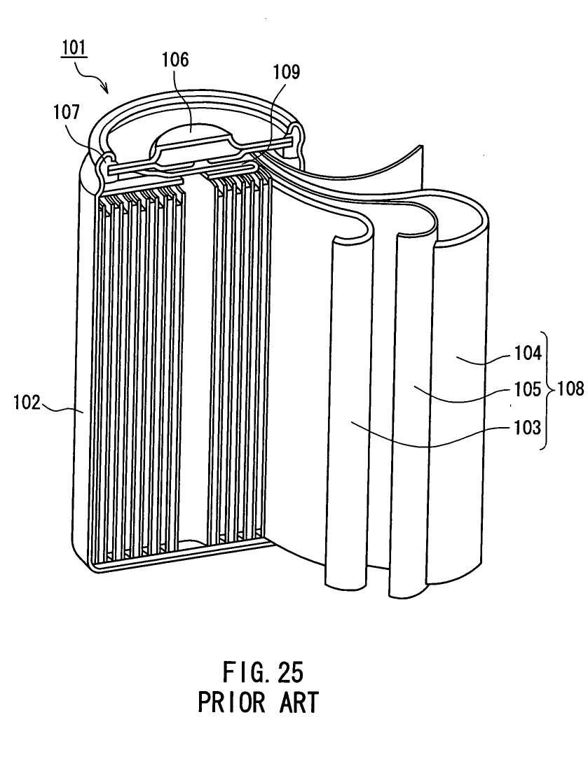

In the battery with the foregoing configuration, the miniaturization of the battery can be realized easily because components such as a tab and a lead required in conventional batteries need not be provided. Thus, for example, the space inside the battery that is irrelevant to a charge/discharge capacity of the battery can be minimized, thereby increasing the energy density of the battery. Moreover, since the number of components provided between the electrode plate group and the terminal portion can be reduced, the internal resistance of the battery can be decreased so that the battery can achieve excellent output characteristics. Furthermore, the battery can achieve high productivity because the process steps required for manufacturing the battery can be reduced due to the reduction of the number of components. Besides, in the battery of the present invention, it is not necessary to provide a caulked portion as seen in the battery of FIG. 25 or a terminal member passing through a housing as disclosed in Patent Documents 1 and 2. Furthermore, since the pair of bottomed cans are used, both end faces of the battery can be formed in a flat shape. Thus, when forming a battery pack, high integration of batteries becomes possible. Note here that the above-described effects are selective, and the battery of the present invention need not necessarily satisfy all the above-described effects at the same time. The effects can be selected, for example, by selecting a battery size, a capacity design, a material to be used, etc.

In the battery of the present invention, the configuration for joining the open end portions of the pair of bottomed cans to each other via the joint ring (i.e., the structure of the joint ring, the structure of the bottomed cans, the structure of the portions between the joint ring and the open end portions of the bottomed cans, etc.) is not particularly limited. Any configuration may be employed as long as the pair of bottomed cans serving as a battery case can be sealed hermetically when the finished product is used as a battery. For example, the configuration may be such that thread portions are formed on peripheral surfaces of the open end portions of the respective bottomed cans and on a peripheral surface of the joint ring, so that the pair of bottomed cans are joined to each other via the joint ring by threading the thread portions of the bottomed cans with the thread portion(s) of the joint ring. Alternatively, the configuration may be such that the peripheral surface of the joint ring and the peripheral surfaces of the open end portions of the bottomed cans are formed in predetermined shapes, so that the pair of bottomed cans are joined to each other via the joint ring by engaging the joint ring and the open end portions of the bottomed cans with each other. In this case, the open end portions of the bottomed cans may be engaged with the joint ring by contracting their diameter. When contracting the diameter of the bottomed cans, the diameter of at least the open end portions thereof may be contracted. Also, it is possible to use a configuration in which the above-described threaded engagement and other engagement are used in combination. For example, the configuration may be such that a thread portion(s) is formed on one peripheral surface of the joint ring while the other peripheral surface of the joint ring is formed in a predetermined shape, so that the joint ring is joined to one of the bottomed cans by threaded engagement, while the joint ring is joined to the other bottomed can by other engagement.

With regard to the joint ring, the configuration for maintaining electrical insulation between the region that is in contact with one of the bottomed cans and the region that is in contact with the other bottomed can is not particularly limited. For example, the joint ring may be configured so that the regions in contact with the pair of bottomed cans are made of resin or so that the entire joint ring is made of resin. Alternatively, the joint ring may be configured so as to include a metal layer and a resin layer, and the electrical insulation may be maintained by the resin layer. By configuring the joint ring so as to include a resin layer and a metal layer, it is possible to improve the strength of the joint ring. Note here that it is not always necessary to integrate the resin layer and the metal layer. For instance, during the manufacture of the battery, the resin layer and the metal layer may be disposed separately. The structure of the joint ring, the material used for the joint ring, etc. may be determined arbitrarily depending on the temperature range when the finished product is used as a battery, the required strength, etc.

The resin used for the joint ring is not particularly limited, and may be, for example, polyamide, polyolefin, polystyrene, polysulphone, fluororesin, or the like. Among them, fluororesin is preferable when the entire joint ring is made of resin, from the aspects of mechanical strength, resistance to moisture permeation, formability, etc. A metal used for the joint ring is not particularly limited, and may be, for example, stainless steel, iron-nickel plated steel, aluminum, or the like. In a resin portion of the joint ring, portions to be in contact with metal portions of the respective bottomed cans preferably are coated with a sealing agent. As the sealing agent, polybutene, blown asphalt, a fluorine-based coating agent, or the like can be used, for example.

The structure, material, constitution, etc. of the power generation component are not particularly limited as long as the power generation component includes a pair of electrodes (a positive electrode and a negative electrode). Any power generation component generally used for a battery can be used. For example, the power generation component may include an electrolyte and an electrode plate group including a separator and a positive electrode and a negative electrode that hold the separator therebetween. In this case, the electrode plate group may be wound, and the electrolyte may be an electrolytic solution having an ionic conductivity. The power generation component with such a configuration is similar to those used for general alkaline storage batteries, lithium batteries, etc. That is to say, the battery according to the present invention can be used as various batteries such as an alkaline storage battery, a nickel-metal hydride battery, a lithium primary battery, and a lithium secondary battery, by selecting the structure, material, constitution, etc. of the power generation component. More specifically, in the case where the battery of the present invention is used as a lithium secondary battery, the positive electrode and the negative electrode may be made of electrode materials that can store and release lithium reversibly (e.g., an electrode material for the positive electrode may be an oxide containing lithium and an electrode material for the negative electrode may be a carbon material or a material containing silicon) and the electrolyte may have a lithium conductivity (e.g., the electrolyte may be a nonaqueous solution of a lithium salt).

The configuration for maintaining the electric connection between the bottomed cans and the electrodes included in the power generation component is not particularly limited. For example, it is only necessary that inner surfaces of the bottoms of the bottomed cans are in contact with the electrodes stably enough to maintain the electroconductivity when the finished product is used as a battery. Moreover, between the bottomed can and the electrode, a conductive member (e.g., a current collector or the like) further may be provided. This configuration may be designed arbitrarily, depending on the required battery characteristics.

The material for the bottomed cans is not particularly limited. For example, any material generally used as a material for a battery case may be used. The material to be used varies depending on the kinds of the battery. In the case of a nickel-metal hydride battery, iron-nickel plated steel, stainless steel, or the like may be used, for example. In the case of a lithium battery, iron-nickel plated steel, stainless steel, aluminum, copper, or the like may be used, for example. The bottomed can to serve as a positive electrode and the bottomed can to serve as a negative electrode may be formed of different materials. In the case of the above-described lithium battery, the bottomed can to serve as a positive electrode (i.e., the bottomed can that is electrically connected to the positive electrode included in the power generation component) may be formed of aluminum, and the bottomed can to serve as a negative electrode (i.e., the bottomed can that is electrically connected to the negative electrode included in the power generation component) may be formed of copper, for example. Also, the material to be used may be determined depending on an electric potential caused in each bottomed can when the finished product is used as a battery.

The size of the bottomed cans is not particularly limited, and may be set, for example, depending on the battery capacity. For instance, when the desired battery capacity is 6000 mAh, the inner diameter of the bottomed cans may be, for example, about 30 mm φ to about 35 mm φ and the depth thereof measured as a total value of the depths of both the bottomed cans may be, for example, about 50 mm to about 55 mm. The wall thickness of the bottomed cans may be, for example, 0.2 mm to 0.6 mm.

A battery pack according to the present invention includes a plurality of the above-described batteries of the present invention, and these batteries are connected in series. This allows the miniaturization of the battery to be realized easily. Furthermore, such a battery pack can exhibit effects based on the above-described effects of the battery. More specifically, for example, it is possible to provide a battery pack with high energy density or a battery pack with excellent output characteristics. Furthermore, for example, by forming both end faces of adjacent batteries in a flat shape, it is possible to eliminate the necessity of providing a connector for connecting the adjacent batteries as disclosed in, for example, Patent Document 3. Note here that an end face of the battery refers to a portion corresponding to an outer surface of the bottom of the above-described bottomed can, for example.

A method for manufacturing a battery according to the present invention includes the steps of (i) joining a joint ring to an open end portion of a first bottomed can; (ii) placing an electrode plate group including a pair of electrodes in the first bottomed can; and (ii) joining an open end portion of a second bottomed can to a portion of the joint ring on a side opposite to a side joined to the first bottomed can, so that the first bottomed can and the second bottomed can are joined to each other via the joint ring. The method further includes the steps of: (a) electrically connecting the first bottomed can to one of the electrodes; and (b) electrically connecting the second bottomed can to the other electrode. According to such a manufacturing method, the above-described battery of the present invention can be obtained. It is to be noted here that the steps (a) and (b) may be performed at any time, as long as they are completed at the stage where the formation of the battery 1 is completed. For example, in the step (iii), the steps (a) and (b) can be completed by joining the first bottomed can and the second bottomed can to each other and bringing the first bottomed can into contact with one of the electrodes and the second bottomed can into contact with the other electrode. Materials and the like of the respective components are the same as those described above with regard to the battery of the present invention, and thus, the description thereof will be omitted here.

A method for manufacturing a battery pack according to the present invention is a method for manufacturing a battery pack in which a plurality of batteries are connected in series. The method includes the steps of: (x) disposing a plurality of batteries so that end faces of adjacent batteries abut against each other; and (y) connecting the adjacent batteries in series by electrically connecting the end faces to each other. The batteries connected in series are the above-described batteries of the present invention. According to such a manufacturing method, it is possible to obtain the above-described battery pack of the present invention.

Hereinafter, the present invention will be described by way of embodiments with reference to the drawings. Note here that in the following embodiments, the same components are denoted with the same reference numerals, and a duplicate description thereof may be omitted.

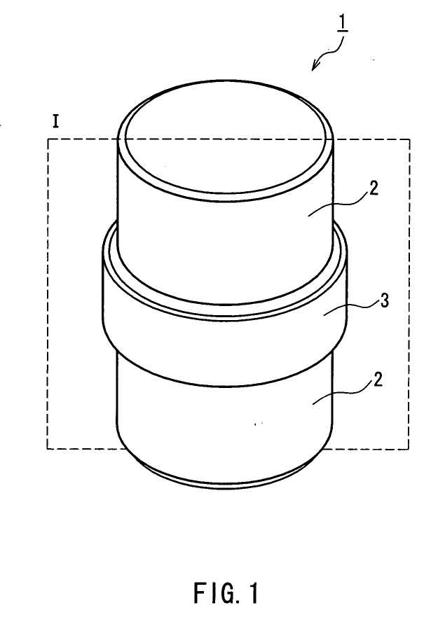

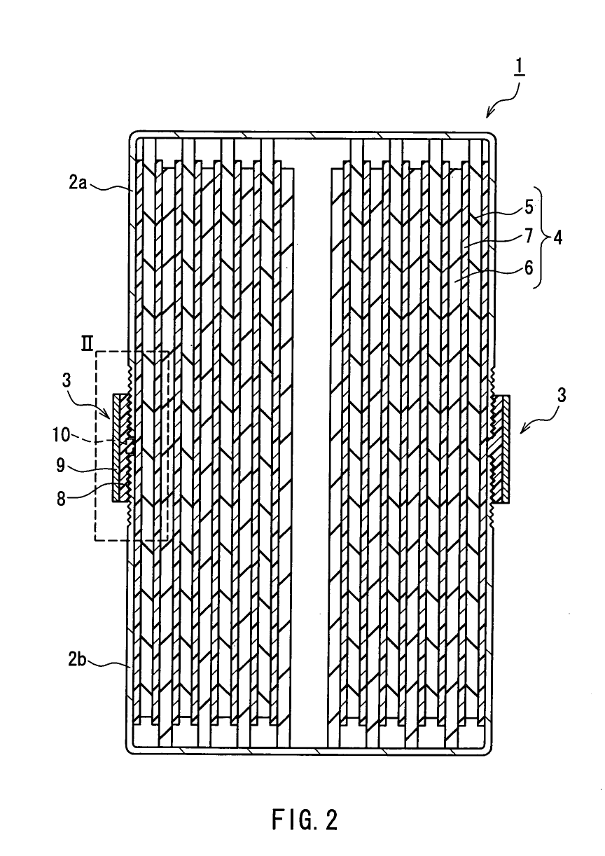

First, a battery of the present invention will be described with reference to the drawings. FIG. 1 and FIG. 2 are views showing an example of a battery according to the present invention. FIG. 2 is a sectional view taken along a plane that is vertical to end faces of a battery 1 shown in FIG. 1 (i.e., along the plane 1 shown in FIG. 1). The battery 1 shown in FIG. 1 and FIG. 2 includes a pair of cylindrical bottomed cans 2, a joint ring 3 for joining open end portions of the respective bottomed cans 2 to each other, and a power generation component including a pair of electrodes, which is accommodated in the joined bottomed cans 2. It is to be noted that, as shown in FIG. 2, the pair of bottomed cans 2 may also be referred to separately as a bottomed can 2a and a bottomed can 2b. In the following description, a letter “a” or “b” similarly may be assigned to current collectors etc.

The power generation component includes an electrolyte and an electrode plate group 4 including a separator 7 and a positive electrode 5 and a negative electrode 6 that hold the separator 7 therebetween. The electrode plate group 4 is wound. The electrolyte is accommodated in the bottomed cans 2 with a part thereof being held by the separator 7. Female thread portions are formed on an inner peripheral surface of the joint ring 3, and male thread portions are formed on outer peripheral surfaces of the open end portions of the respective bottomed cans 2. The bottomed can 2a and the bottomed can 2b are joined to each other via the joint ring 3 by threading the male thread portions with the female thread portions. The joint ring 3 has a structure in which a resin layer 8 and a metal layer 9 are laminated, with the resin layer 8 being an innermost layer. With this structure, on the inner peripheral surface of the joint ring 3, a region that is in contact with the bottomed can 2a is electrically insulated from a region that is in contact with the bottomed can 2b. Furthermore, the positive electrode 5 protrudes from one end face of the electrode plate group 4 so that the positive electrode 5 is electrically connected to an inner surface of the bottom of the bottomed can 2a, and the negative electrode 6 protrudes from the other end face of the electrode plate group 4 so that the negative electrode 6 is electrically connected to an inner surface of the bottom of the bottomed can 2b. The amount by which the positive electrode 5 and the negative electrode 6 protrude from the respective end faces (i.e., the amount of protrusion) may be about 0.5 mm to about 2.5 mm, for example.

With this configuration, it is possible to provide the battery 1 in which the bottomed can 2a serves as a positive electrode and the bottomed can 2b serves as a negative electrode. Furthermore, as shown in FIG. 2, inside the battery 1, a space for accommodating a tab, a lead, etc. as seen in conventional batteries is not provided, and the electrode plate group 4 occupies almost the entire interior space of the pair of bottomed cans 2. Thus, the battery 1 can achieve high energy density. Moreover, since there are no components such as a tab between the positive electrode 5 and the bottomed can 2a or between the negative electrode 6 and the bottomed can 2b, the internal resistance of the battery 1 can be decreased so that the battery 1 can achieve excellent output characteristics.

Moreover, the manufacturing process of the battery 1 can be simplified as compared with that of conventional batteries. For example, for manufacturing the battery 101 shown in FIG. 25, after the power generation component has been placed in the battery case 102, it is necessary to perform the steps of attaching the tab 109 to the sealing plate 106, folding the tab 109, fixing the sealing plate by caulking, etc. In contrast, the battery 1 shown in FIG. 2 can be obtained, in the most simplified case, by threading the bottomed can 2b with the joint ring 3, placing the electrode plate group 4 and the like in the bottomed can 2b, and threading the bottomed can 2a with the joint ring 3, for example. Thus, it is possible to provide the low-cost battery 1 that is composed of a minimum number of components and thus can achieve high productivity. An example of a method for manufacturing a battery according to the present invention will be described later.

In the battery 1 shown in FIG. 2, the positive electrode 5 and the bottomed can 2a, and the negative electrode 6 and the bottomed can 2b may be merely in contact with each other, as long as electric connection therebetween can be maintained for a required period. Alternatively, the positive electrode 5 and the bottomed can 2a, and the negative electrode 6 and the bottomed can 2b may be electrically connected to each other by at least one selected from welding and brazing. By welding or brazing, the internal resistance of the battery 1 can be decreased further so that the battery 1 can achieve still more excellent output characteristics. Besides, the reliability of the battery 1 can be improved further. The type of welding is not particularly limited, and may be, for example, laser welding, resistance welding, or the like.

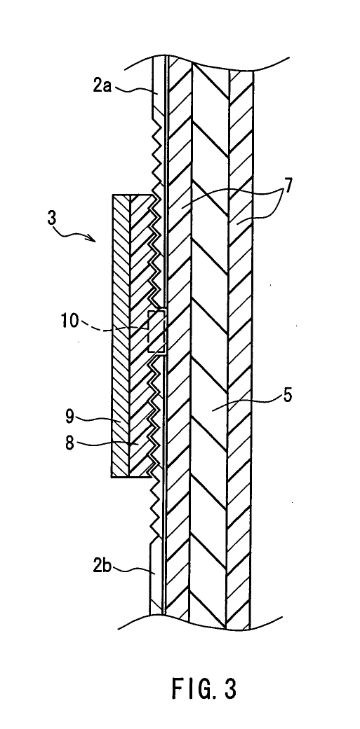

In the battery 1 shown in FIG. 2, the joint ring 3 has an annular contact portion 10. FIG. 3 is an enlarged view of a region II in the battery 1 shown in FIG. 2. As shown in FIG. 3, the joint ring 3 has the annular contact portion 10, and an open end of the bottomed can 2a and an open end of the bottomed can 2b abut against each other via the contact portion 10. With the foregoing configuration, the sealing integrity for an interior space of the pair of bottomed cans 2 can be improved, thereby further improving the reliability of the battery 1. Moreover, since the sealing conditions of the battery 1 can be controlled with the dimensional accuracy of the contact portion 10 during the manufacture of the battery, it is possible to provide the battery 1 with higher productivity. When both the bottomed can 2a and the bottomed can 2b are in direct contact with the contact portion 10, the contact portion 10 needs to be electrically insulating. However, when an electrically insulating material is disposed between the contact portion 10 and the bottomed can 2a and/or bottomed can 2b, the contact portion 10 need not be electrically insulating. In the example shown in FIG. 2, the contact portion 10 is a part of the resin layer 8.

Furthermore, in the battery 1 shown in FIG. 2, an outermost periphery of the electrode plate group 4 is the separator 7, which is electrically insulating. When the outermost periphery of the electrode plate group 4 is an electrically insulating material, it is possible to reduce the possibility that the electrodes included in the electrode plate group 4 might be in direct contact with the bottomed cans 2a and 2b and the joint ring 3. Therefore, the occurrence of an internal short circuit and the like can be reduced, so that the reliability of the battery 1 further is improved. A similar effect also can be obtained in the case where, for example, the electrode plate group 4 excluding the region for maintaining the electric connection to the bottomed cans 2 is covered with an electrically insulating material such as resin (e.g., a film made of resin), instead of configuring the electrode plate group 4 so that the outermost periphery is the separator 7. Alternatively, the inner surfaces of the bottomed cans 2 excluding the regions for maintaining the electric connection to the respective electrodes in the electrode plate group 4 may be covered with an electrically insulating material such as resin (e.g., a film made of resin).

The structure of the thread portions formed in the bottomed cans 2 and the joint ring 3 (e.g., a pitch or the like of the thread portions) is not particularly limited. The thread portions formed in the respective bottomed can 2 and the thread portions formed in the joint ring 3 may be taper threads. By using the taper threads, the battery 1 with improved sealing can be obtained. Moreover, in this case, it is possible to improve the sealing of the battery 1 by, for example, controlling torque when rotating the bottomed cans 2 and/or the joint ring 3 during the manufacture of the battery 1.

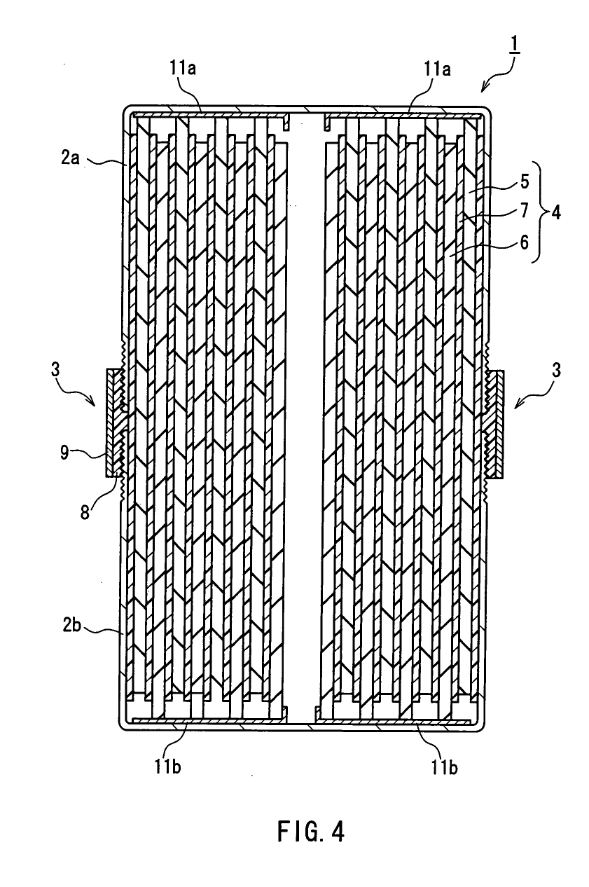

FIG. 4 is a sectional view showing another example of a battery according to the present invention. In a battery 1 shown in FIG. 4, a current collector 11a further is disposed between a positive electrode 5 and the bottom of a bottomed can 2a, and a current collector 11b further is disposed between a negative electrode 6 and the bottom of a bottomed can 2b. The positive electrode 5 and the current collector 11a; the current collector 11a and the bottomed can 2a; the negative electrode 6 and the current collector 11b; and the current collector 11b and the bottomed can 2b are electrically connected to each other, respectively. In the battery 1 configured as above, adhesion between the bottomed cans 2 and the electrodes included in an electrode plate group 4 can further be enhanced. With the foregoing configuration, a highly reliable battery 1 that can achieve more excellent output characteristics can be obtained. Although the current collectors 11a and 11b are disposed respectively on the bottomed can 2a side (i.e., the positive electrode side) and the bottomed can 2b side (the negative electrode side) in the battery 1 shown in FIG. 4, a current collector may be disposed on either one of these sides.

The current collectors 11 and the bottomed cans 2 may be merely in contact with each other, as long as electric connection therebetween can be maintained for a required period. Alternatively, the current collectors 11 and the bottomed cans 2 may be electrically connected to each other by at least one selected from welding and brazing. By welding or brazing, the internal resistance of the battery 1 can further be decreased so that the battery 1 can achieve still more excellent output characteristics. Besides, the reliability of the battery 1 can be improved further. The type of welding is not particularly limited, and may be, for example, laser welding, resistance welding, or the like. Note here the above description also applies to the relationship between the current collectors 11 and the electrodes included in the electrode plate group 4.

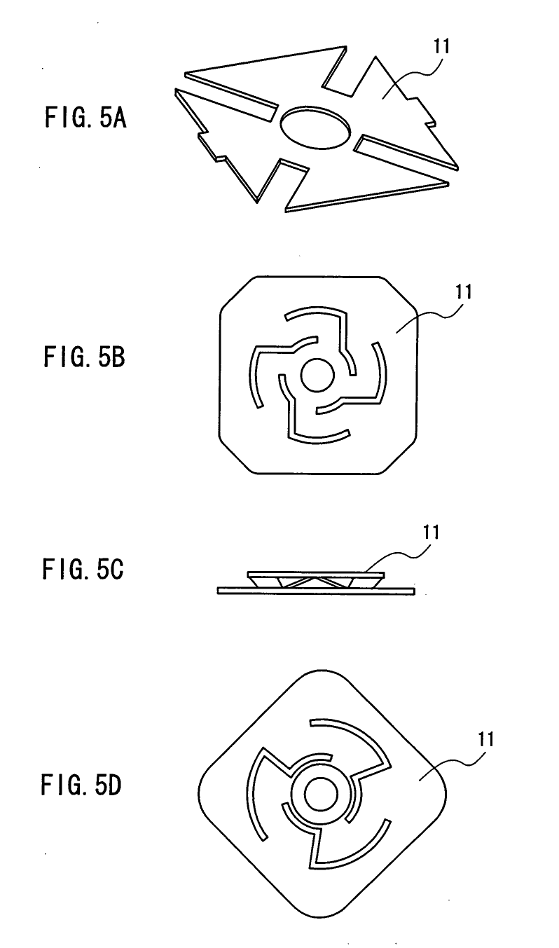

The material for the current collector 11 is not limited as long as it is conductive and hardly subjected to corrosion and the like in the battery 1. In the case of an alkaline storage battery, nickel, nickel plated steel plate, or the like may be used, for example. In the case of a lithium battery, copper (for a current collector to be disposed on the negative electrode side) and aluminum (for a current collector to be disposed on the positive electrode side) may be used, for example. It is only necessary that the current collector 11 exhibits electrical conductivity as a whole, and thus an electrically insulating material may be contained therein. The structure of the current collector 11 is not particularly limited, and any generally used current collector may be used, for example. Examples of the current collector 11 are shown in FIGS. 5A to 5D. The current collector 11 shown in FIG. 5A is a so-called burring current collector (i.e., a current collector produced by burring). The burring current collector is advantageous in terms of current-collecting property, weld strength, etc. The current collectors 11 shown in FIGS. 5B to 5D are so-called disc spring-type current collectors. The disc spring-type current collector is advantageous because it can absorb the variation in height between electrode plate groups 4, thereby achieving a uniform overall height. FIG. 5C is a schematic side view of the current collector 11 shown in FIG. 5B.

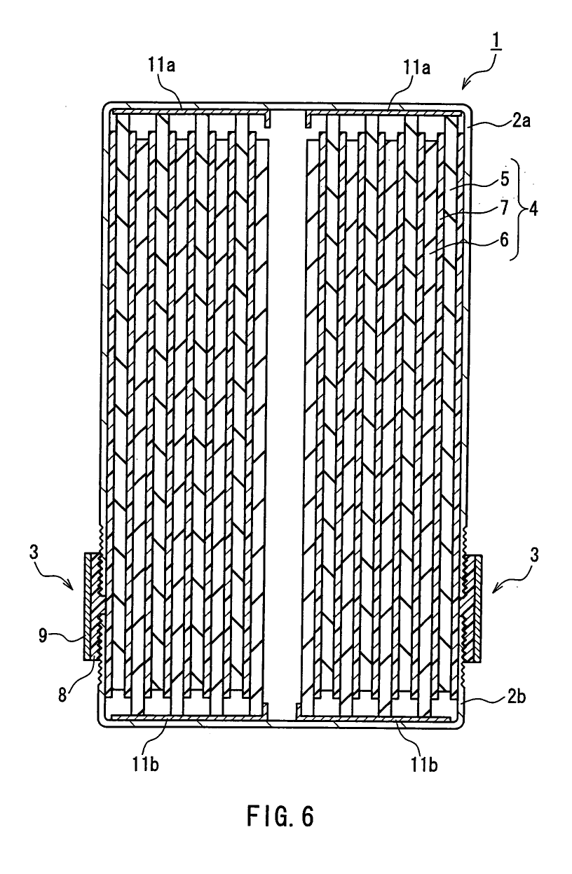

FIG. 6 is a sectional view showing still another example of a battery according to the present invention. In a battery 1 shown in FIG. 6, the depth of a bottomed can 2a is different from that of a bottomed can 2b. When the bottomed cans 2a and 2b have different depths, a joint ring 3 is located closer to one end face of the battery 1, as shown in FIG. 6. The battery 1 configured as above can accommodate a greater amount of electrolyte than the battery having a pair of bottomed can 2a and 2b with substantially the same depth by, for example, placing the electrode plate group 4 in the deeper bottomed can 2a and then placing the electrolyte in the bottomed can 2a in the state where the joint ring 3 is joined thereto (e.g., pouring an electrolytic solution to the bottomed can 2a) during the manufacture of the battery 1.

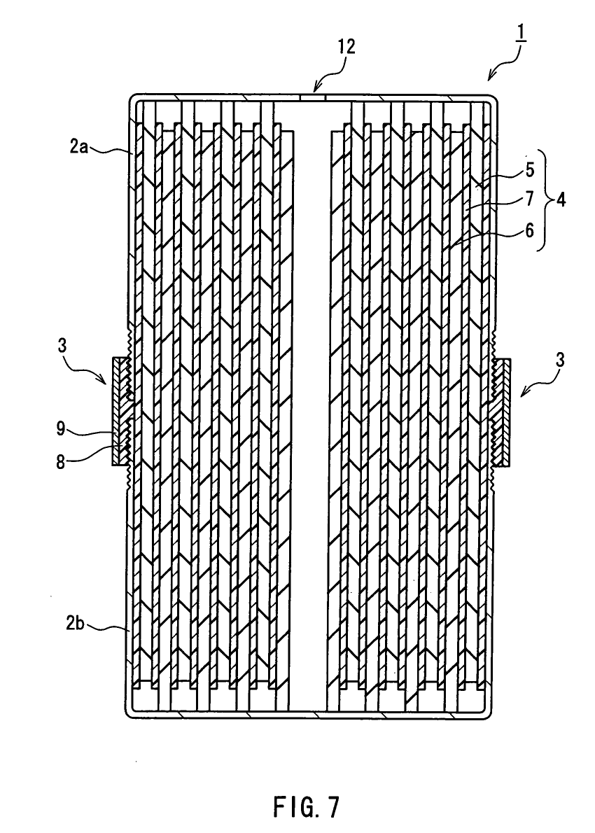

FIG. 7 is a sectional view showing still another example of a battery according to the present invention. In a battery 1 shown in FIG. 7, a through hole 12 is formed on the bottom of a bottomed can 2a, and this through hole 12 is sealed. Such a through hole 12 may be used, for example, for adding an electrolyte during the manufacture of the battery 1. Moreover, when trouble such as temperature rise or an increase in internal pressure occurs during the use of the battery 1, the through hole 12 also can serve as a safety valve, thereby achieving the battery 1 with enhanced safety. The configuration for sealing the through hole 12 is not particularly limited. For example, the through hole 12 may be sealed with a lid having a safety valve. The structure of the safety valve, the structure of the lid, etc. are not particularly limited. For example, any safety valve and the like generally used for a battery may be employed. The pressure range within which the safety valve operates may be set arbitrarily.

The through hole 12 may be sealed with a thin film. For example, when temperature rise or an increase in internal pressure occurs in the battery 1, the thin film breaks, thereby serving as a safety valve. The kind of the thin film is not particularly limited. For example, the thin film may be made of the same material as that for the bottomed cans 2 or may be made of resin. Alternatively, the thin film may include a plurality of layers made of different materials. The thickness of the thin film may be in the range from 10 μm to 100 μm, for example. The pressure range within which the thin film breaks can be set by changing the thickness or the material of the thin film. Note here that the through hole 12 may be sealed by using a thin film and a safety valve in combination. For example, a safety valve may be disposed in the through hole 12, and thereafter, the through hole 12 may be sealed with the thin film.

Although the through hole 12 is formed only in the bottomed can 2a in the example shown in FIG. 7, both the bottomed cans 2a and 2b may have through holes. The position at which the through hole 12 is formed in not limited to the bottom of the bottomed can 2, but may be formed at any desired position in the bottomed can 2. Furthermore, the number of through holes 12 is not limited to one, but a plurality of through holes 12 may be formed. For example, in addition to a through hole 12 that serves as a safety valve, another through hole 12 used for adding an electrolyte may be provided. In the case where the through hole 12 also is used for adding the electrolyte, an inner diameter thereof may be, for example, in the range from 1 mm to 3 mm.

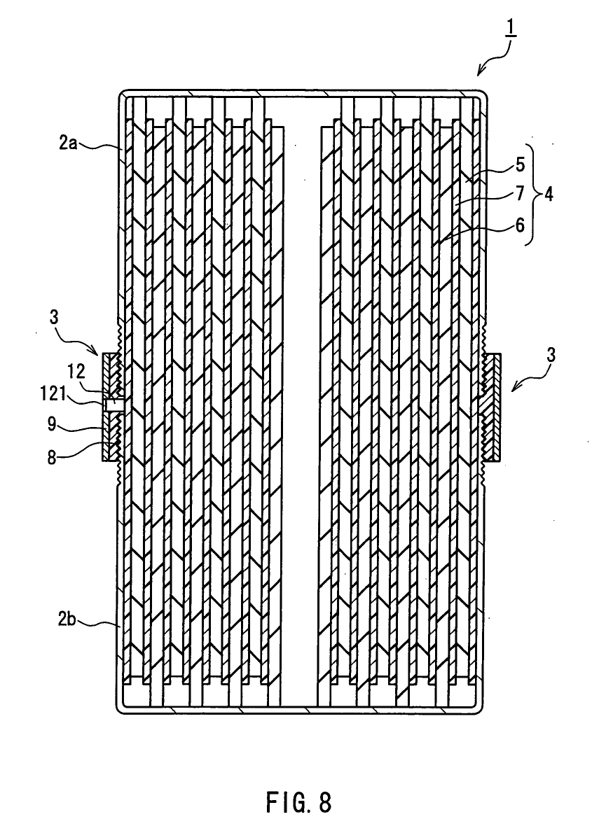

FIG. 8 is a sectional view showing still another example of a battery according to the present invention. In a battery 1 shown in FIG. 8, a through hole 12 is formed in a joint ring 3, and this through hole 12 is sealed with a thin film 121. When the through hole 12 is formed in the joint ring 3, a similar effect to that obtained when the through hole 12 is formed in the bottomed can 2 also can be obtained. The position at which the through hole 12 is formed in the joint ring 3 is not particularly limited as long as a pair of bottomed cans 2a and 2b can be joined to each other.

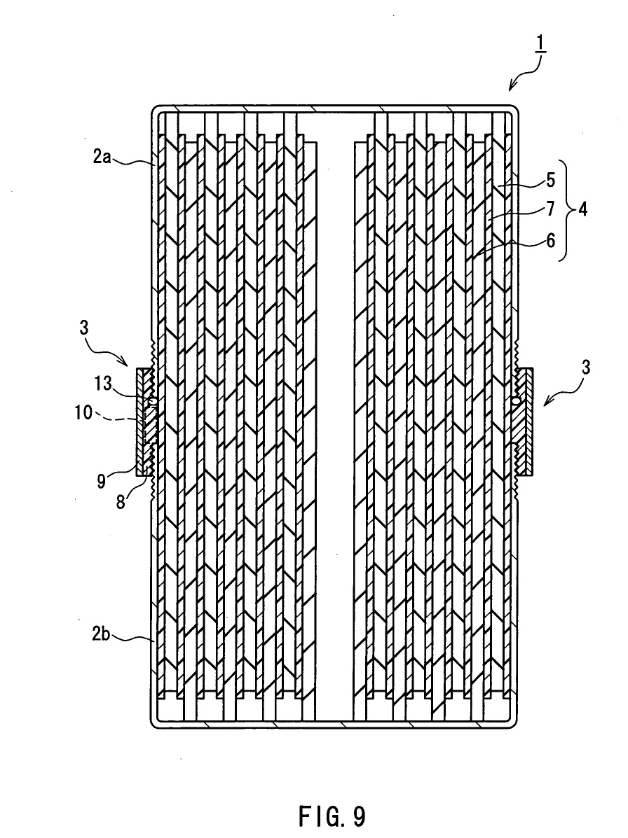

FIG. 9 is a sectional view showing still another example of a battery according to the present invention. In a battery 1 shown in FIG. 9, a joint ring 3 has an annular contact portion 10, and between the contact portion 10 and a bottomed can 2a, an O-ring 13 made of an elastic body further is disposed as a sealing member. An open end of the bottomed can 2a and an open end of the bottomed can 2b abut against each other via the contact portion 10 and the O-ring 13. With this configuration, the battery 1 with improved sealing can be obtained. In the battery 1, when the sealing member made of an elastic body (e.g., the O-ring 13) is disposed in the state where it is compressed at a predetermined compression ratio, the sealing member not only functions to seal the battery 1 but also functions as a safety valve. The predetermined compression ratio may be set to be within the range where the safety valve does not operate when the battery 1 is in the normal condition. Moreover, the predetermined compression ratio can be controlled precisely by defining the overall height of the battery 1.

The material for the sealing member is not particularly limited, and may be, for instance, resin, rubber, a metal, or the like. However, because it is necessary to prevent the occurrence of an electric short circuit between the pair of bottomed cans 2, the sealing member preferably is electrically insulating in the case where the contact portion 10 is conductive. The type of the O-ring 13 used as a sealing member in the example shown in FIG. 9 is not particularly limited. For example, a generally used O-ring may be used. Although the sealing member is disposed only between the contact portion 10 and the bottomed can 2a in the example shown in FIG. 9, another sealing member may also be disposed between the contact portion 10 and the bottomed can 2b.

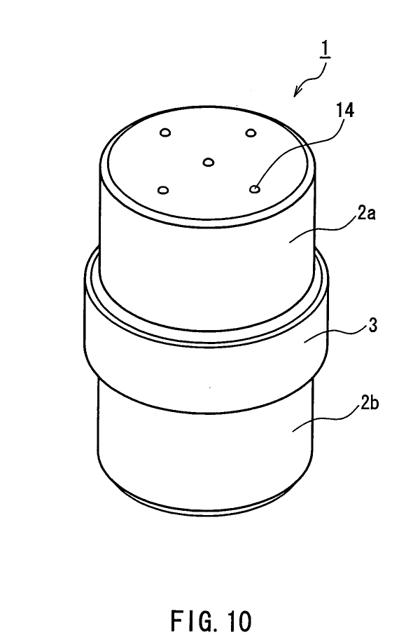

FIG. 10 is a schematic view showing still another example of a battery according to the present invention. In a battery 1 shown in FIG. 10, projections 14 are formed on an outer surface of the bottom of a bottomed can 2a (i.e., on an end face of the bottomed can 2a). The battery 1 configured as above is advantageous because, when a plurality of such batteries 1 are connected to each other to form a battery pack as described later, an area of a contact portion between adjacent batteries 1 can be controlled by controlling the size of the projections 14. Thus, it is possible to reduce the connection resistance between the adjacent batteries 1. Although the projections 14 are formed only in the bottomed can 2a in FIG. 10, the projections 14 may be formed on end faces of both the bottomed cans 2a and 2b. The shape of the projection 14 is not particularly limited. For example, the projection 14 may be provided merely as a protruding portion. Furthermore, not only the projection 14 but also a recess may be formed on an end face of the bottomed can 2. For example, by forming a projection 14 on an end face of one of the adjacent batteries 1 and a recess on an end face of the other battery 1, aligning the projection 14 with the recess, and then connecting them to each other, it is possible to achieve closer contact between the adjacent batteries 1.

Hereinafter, other variations of a battery according to the present invention will be described. The battery according to the present invention may have the following configurations, for example. Note here that the battery of the present invention can exhibit similar effects to those described above, even when it has the following configurations. The battery according to the present invention is by no means limited to the above-descried specific examples or to the variations described below.

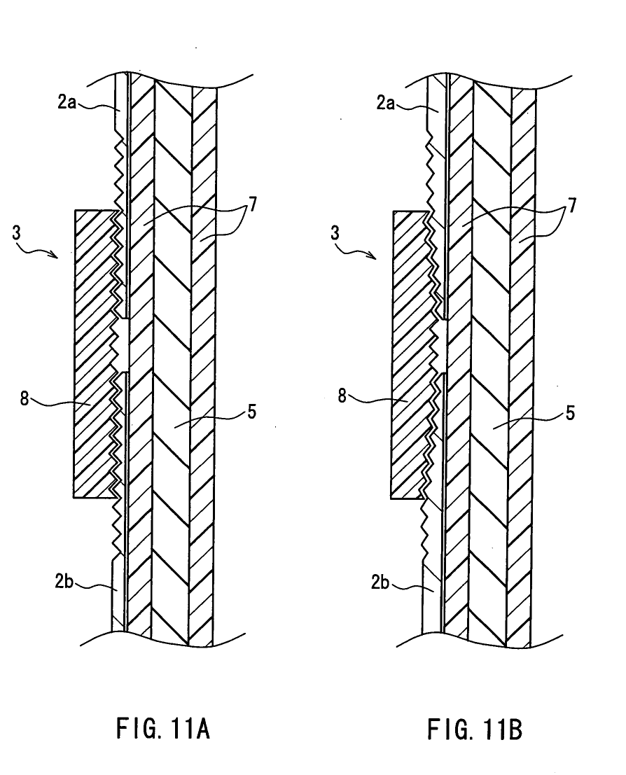

FIGS. 11A and 11B are enlarged views of a region including a joint ring 3 in examples of a battery according to the present invention. As shown in FIG. 11A, the battery of the present invention may be configured so that a joint ring 3 does not have the contact portion 10 shown in FIG. 3. In this case, in order to prevent the contact between bottomed cans 2a and 2b, both the bottomed cans 2a and 2b may be threaded with the joint ring 3. When the joint ring 3 does not have the contact portion 10, it is preferable that a thread portion formed in the joint ring 3 and a thread portion formed in each bottomed can 2 are taper threads, from the aspect of sealing of the battery 1. FIG. 11B shows an example where these thread portions are all taper threads. The specific shape of the taper thread is not particularly limited. Although the joint ring 3 is made of resin in the examples shown in FIGS. 11A and 11B, the joint ring 3 may include a metal layer 9 as in the example shown in FIG. 2.

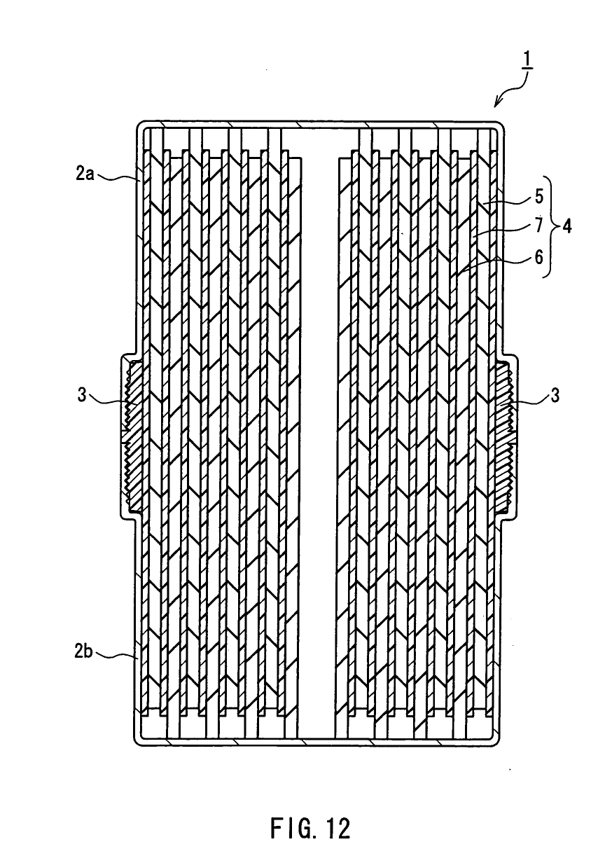

FIG. 12 is a sectional view showing still another example of a battery according to the present invention. In a battery 1 shown in FIG. 12, male thread portions are formed on an outer peripheral surface of a joint ring 3, and female thread portions are formed on inner peripheral surfaces of open end portions of the respective bottomed cans 2. The pair of bottomed cans 2a and 2b are joined to each other via the joint ring 3 by threading the female thread portions with the male thread portions.

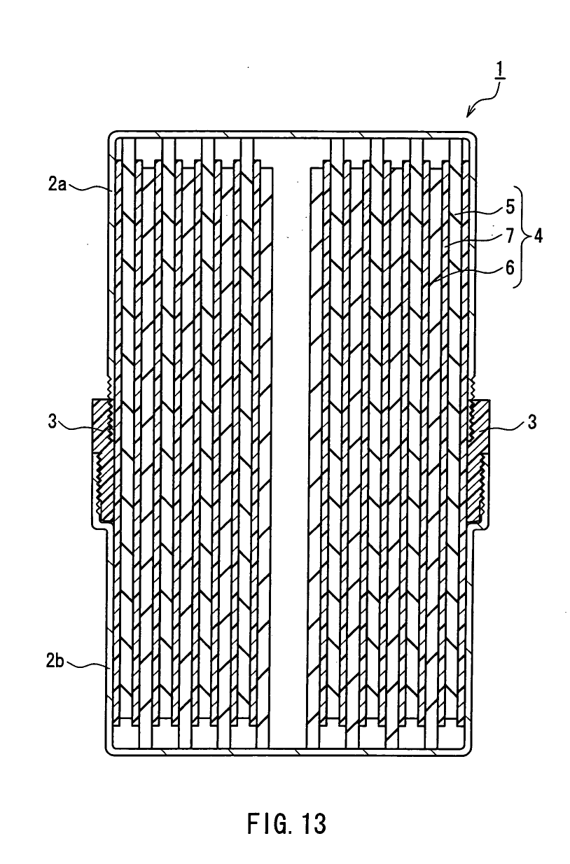

FIG. 13 is a sectional view showing still another example of a battery according to the present invention. In a battery 1 shown in FIG. 13, a male thread portion is formed on an outer peripheral surface of an open end portion of a bottomed can 2a, and a female thread portion is formed on an inner peripheral surface of an open end portion of the bottomed can 2b. Furthermore, a male thread portion is formed on an outer peripheral surface of a portion on one side of a joint ring 3, and a female thread portion is formed on an inner peripheral surface of a portion on the other side of the joint ring 3. The pair of bottomed cans 2a and 2b are joined to each other via the joint ring 3 by threading the male thread portion of the bottomed can 2a with the female thread portion of the joint ring 3 and threading the female thread portion of the bottomed can 2b with the male thread portion of the joint ring 3.

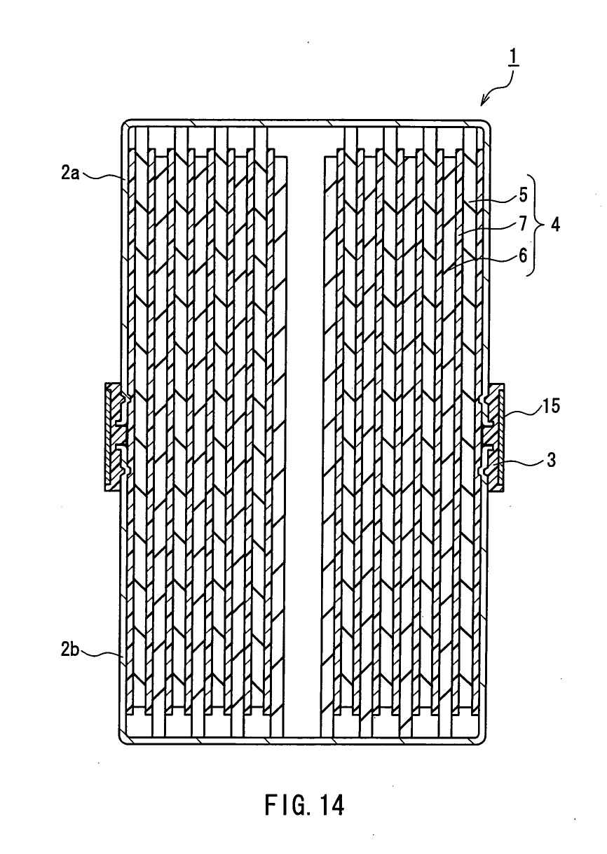

FIG. 14 is a sectional view showing still another example of a battery according to the present invention. In a battery 1 shown in FIG. 14, a pair of bottomed cans 2a and 2b are joined to each other via a joint ring 3 by engaging the joint ring 3 with open end portions of the bottomed cans 2a and 2b. A power generation component accommodated in an interior space of the pair of bottomed cans 2a and 2b is the same as that used in the example shown in FIG. 2. Furthermore, on an outer peripheral surface of the joint ring 3, a strip (belt) 15 for applying force toward the internal circumference of the joint ring 3 further is provided. With this configuration, it is possible to provide the battery 1 in which the joint ring 3 and the bottomed cans 2a and 2b are more reliably engaged with each other by the use of the belt 15. As the belt 15, a belt made of a metal or resin may be used, for example.

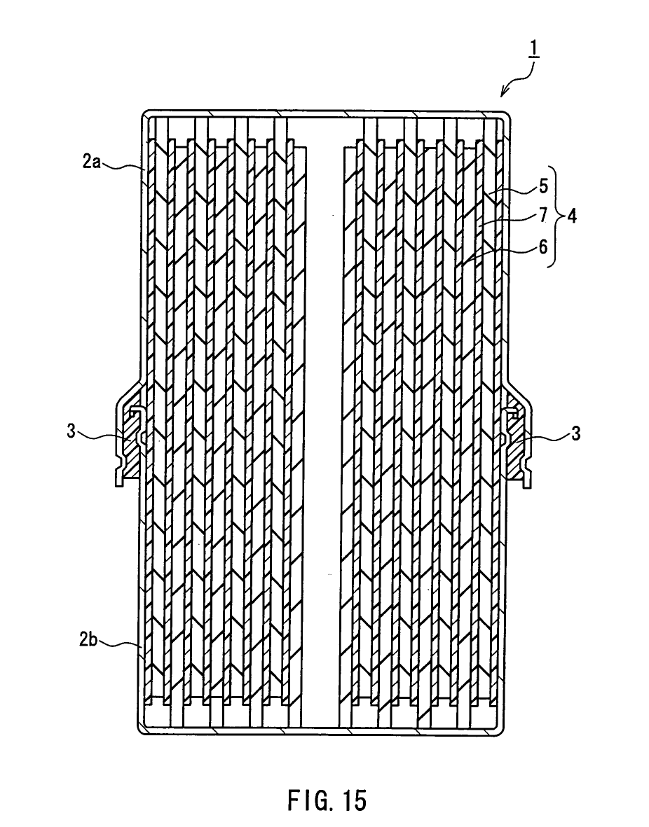

FIG. 15 is a sectional view showing still another example of a battery according to the present invention. In a battery 1 shown in FIG. 15, a pair of bottomed cans 2a and 2b are joined to each other via a joint ring 3 by engaging the joint ring 3 with open end portions of the bottomed cans 2a and 2b. In the battery 1 shown in FIG. 15, an outer peripheral surface of the joint ring 3 is engaged with an inner peripheral surface of an open end portion of the bottomed can 2a, and an inner peripheral surface of the joint ring 3 is engaged with an outer peripheral surface of an open end portion of the bottomed can 2b. In this case, the diameter of the bottomed can 2a may be contracted. By contracting the diameter of the bottomed can 2a, it is possible to provide the battery 1 in which the joint ring 3 and the bottomed cans 2 are more reliably engaged with each other. The region of the bottomed can 2a where the diameter thereof is contracted is not particularly limited. For example, the diameter of the open end portion of the bottomed can 2a, more specifically, the diameter of a portion of the bottomed can 2a that is in contact with the joint ring 3 may be contracted. The contraction of the diameter of the bottomed can 2a may be as follows, for example: when an inner diameter of a portion to be contacted is 30 mm φ, the inner diameter of the portion may be contracted to about 29.5 mm φ.

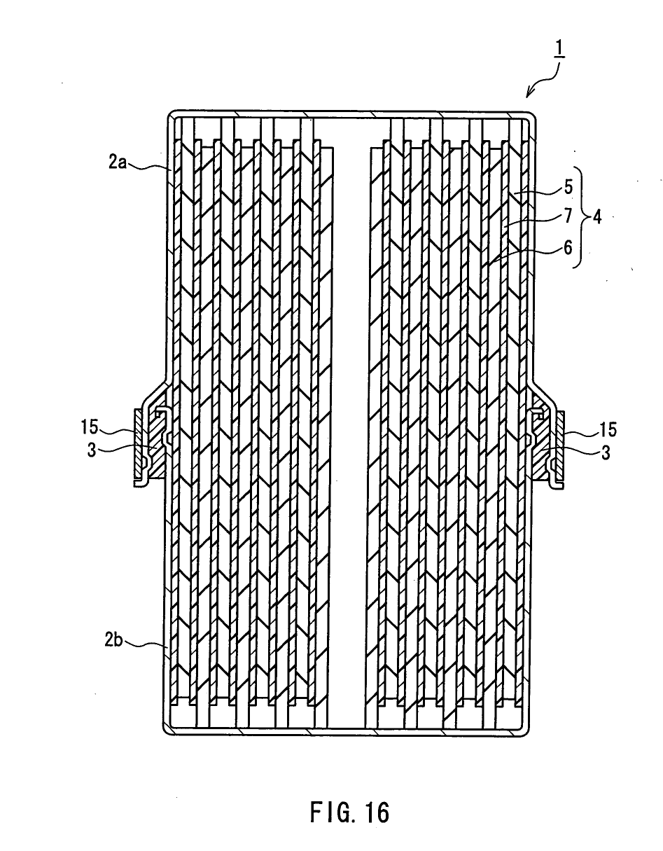

FIG. 16 is a sectional view showing still another example of a battery according to the present invention. A battery 1 shown in FIG. 16 has the same configuration as that of the battery 1 shown in FIG. 15 except that, on an outer peripheral surface of an open end portion of the bottomed can 2a, a belt 15 for applying force toward the internal circumference of the bottomed can 2a further is provided. With this configuration, it is possible to provide the battery 1 in which the joint ring 3 and the bottomed cans 2a and 2b are engaged with each other more reliably. When contracting the diameter of the bottomed can 2a in the battery 1 configured as above, the belt 15 may be provided after the diameter of the bottomed can 2a has been contracted, for example.

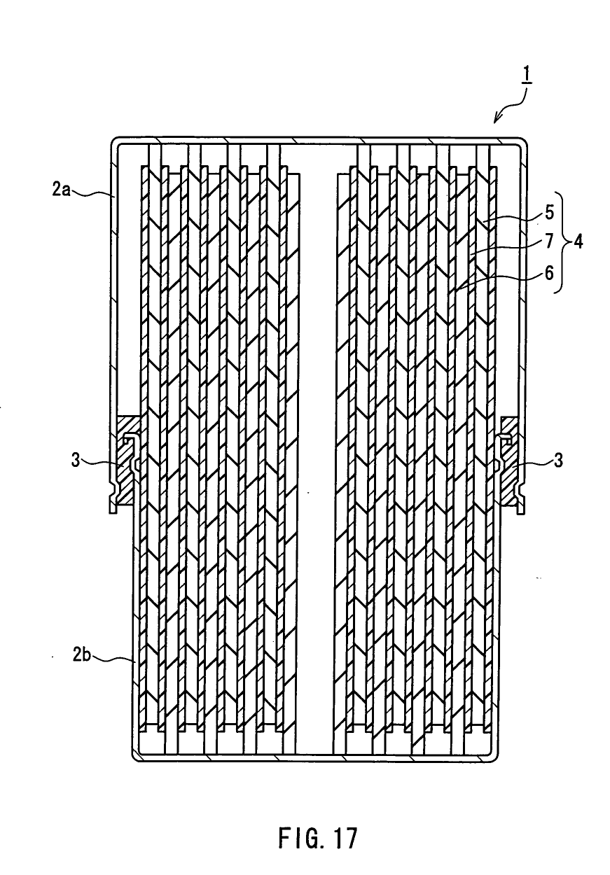

FIG. 17 is a sectional view showing still another example of a battery according to the present invention. In a battery 1 shown in FIG. 17, a pair of bottomed cans 2a and 2b are joined to each other via a joint ring 3 by engaging the joint ring 3 with open end portions of the bottomed cans 2a and 2b. More specifically, in the battery 1 shown in FIG. 17, an outer peripheral surface of the joint ring 3 is engaged with an inner peripheral surface of an open end portion of the bottomed can 2a, and an inner peripheral surface of the joint ring 3 is engaged with an outer peripheral surface of an open end portion of the bottomed can 2b. In the battery 1 shown in FIG. 17, the portion near the joint ring 3 is configured in the same manner as in the battery 1 shown in FIG. 15. However, the battery 1 shown in FIG. 17 differs from the battery 1 shown in FIG. 15 in that the inner diameter of the bottomed can 2a is different from that of the other bottomed can 2b.

According to the configurations shown in FIG. 14 to FIG. 17, it is possible to provide a battery with high energy density or a battery whose battery characteristics, such as output characteristics, are excellent. The shapes of the peripheral surfaces of the open end portions of the bottomed cans 2a and 2b and the peripheral surface of the joint ring 3 to be engaged with each other are not particularly limited.

Although a battery 1 as one aspect of the present invention has been specifically described above by way of embodiments, it is to be noted that the battery of the present invention is by no means limited to the above-described embodiments. For example, although in the above embodiments the battery has a joint ring with a round outer shape, the shape of the joint ring is not limited thereto. For example, the outer shape of the joint ring may be formed in a polygonal shape, such as a hexagonal shape or an octagonal shape. When a plurality of battery packs described later are formed, this allow the plurality of battery packs to be integrated with a certain distance being kept between adjacent battery packs and also allows the plurality of battery packs to be maintained stably. If a certain distance can be kept between the adjacent battery packs, it is possible to send cooling air between the adjacent battery packs during the use of the battery packs, for example.

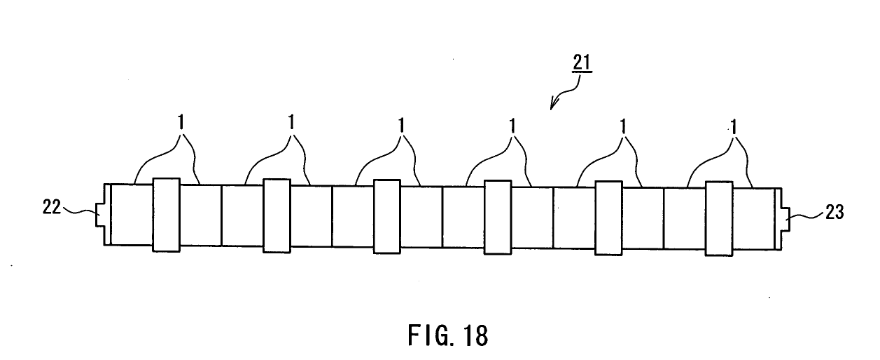

Next, a battery pack according to the present invention will be described with reference to the drawings. FIG. 18 is a plan view showing an example of a battery pack according to the present invention.

A battery pack 21 shown in FIG. 18 includes a plurality of the above-described batteries 1 of the present invention, and these batteries 1 are connected in series. The battery pack 21 configured as above can be miniaturized easily and besides, can produce effects based on the above-described effects of the battery 1.

Although six batteries 1 are connected in series in the example shown in FIG. 18, the number of batteries 1 connected in series is not particularly limited. The number of batteries 1 may be determined arbitrarily as required. Furthermore, although a positive terminal 22 and a negative terminal 23 are disposed on both end faces of the battery pack 21, respectively, it is not always necessary to provide both the terminals and they may be provided as required. The positive terminal 22 and/or the negative terminal 23 may be disposed by, for example, welding the terminal on the end face of the battery 1 disposed on the end of the battery pack 21. An outer surface of the battery pack 21 may be covered with resin, because this allows the outer surface of the battery pack 21 to be protected. In this case, the resin used is not particularly limited, and may be, for instance, an elastic resin.

The structure for connecting the batteries 1 in series (hereinafter referred to as the “connecting structure”) is not particularly limited, as long as electric connection between adjacent batteries 1 can be maintained. Note here that it is not necessary that all the batteries 1 in the battery pack 21 are connected by a common connecting structure, but the batteries 1 may be connected in series by a plurality of different connecting structures. In the battery pack 21 shown in FIG. 18, the plurality of batteries 1 are connected in series by disposing the batteries 1 so that end faces of adjacent batteries 1 abut against each other.

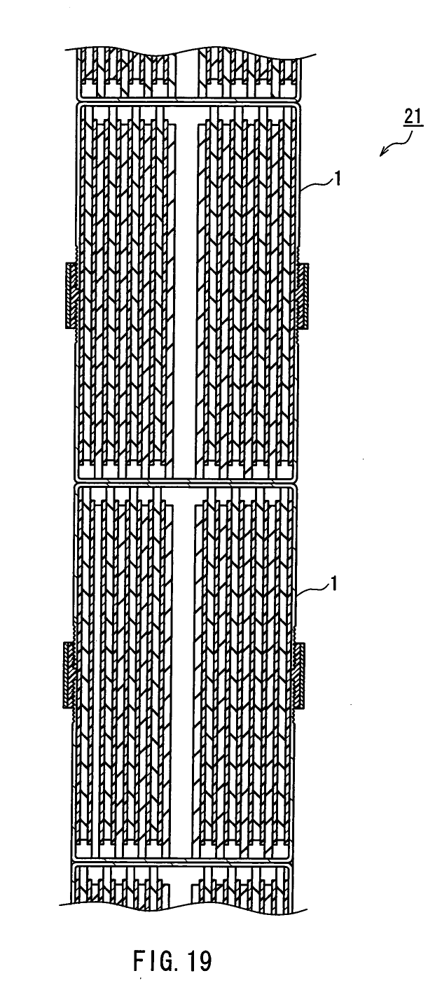

FIG. 19 is a sectional view showing another example of a battery pack according to the present invention. In a battery pack 21 shown in FIG. 19, a plurality of batteries 1 are connected in series by disposing the batteries 1 so that end faces of adjacent batteries 1 abut against each other directly. The end faces of adjacent batteries 1 are welded to each other. In the battery pack 21 configured as above, electric connection between adjacent batteries 1 can be maintained more reliably. Moreover, the strength of the battery pack 21 as a whole can be enhanced. The type of welding to be performed for connecting the end faces is not particularly limited, and may be, for instance, laser welding or the like.

The battery 1 used in the battery pack 21 may be the battery 1 having projections 14 on an end face thereof as shown in FIG. 10. In this case, in the battery pack 21, adjacent batteries 1 are connected in series via the projections 14. Moreover, the projections 14 can serve as projections for use in projection welding. Thus, when the projections 14 are formed on the end face of at least one of adjacent batteries 1, the above-described welding may be projection welding.

Although end faces of adjacent batteries 1 abut against each other directly in the battery pack 21 shown in FIG. 19, the end faces may abut against each other via another component disposed therebetween. The component may be formed of any material and may have any structure as long as it does not interfere with electric connection between adjacent batteries 1.

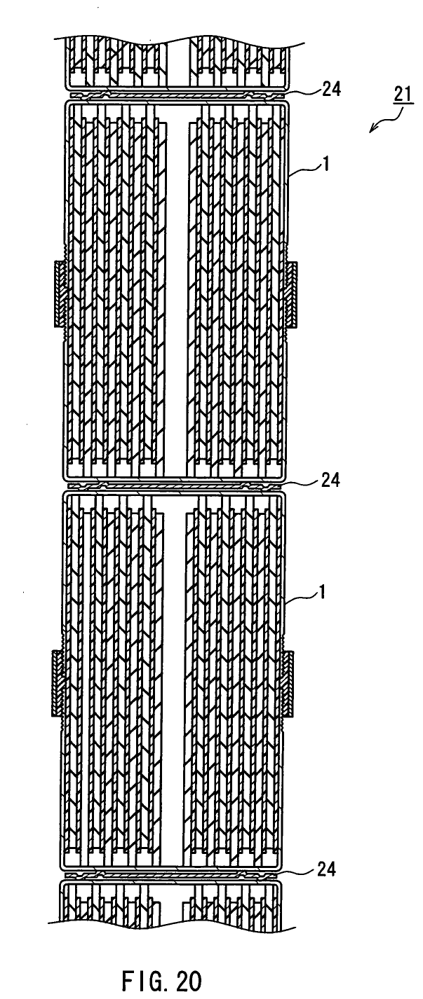

FIG. 20 is a sectional view showing still another example of a battery pack according to the present invention. In a battery pack 21 shown in FIG. 20, a conductive plate 24 is disposed between end faces of adjacent batteries 1, and the adjacent batteries 1 are connected in series via the plate 24. In the battery pack 21 configured as above, electric connection between adjacent batteries 1 can be maintained more reliably.

The material for the plate 24 is not particularly limited as long as it is conductive. For example, the plate 24 may be made of nickel, iron, a nickel plated steel plate, or the like. As in the case of the above-described current collector 11, it is only necessary that the plate 24 exhibits electrical conductivity as a whole, and thus an electrically insulating material may be contained therein. The size of the plate 24 is not particularly limited, and may be substantially the same as that of the end face of the battery 1, for example. The thickness of the plate 24 is not particularly limited, and may be, for example, in the range from 0.2 mm to 1.0 mm. Note here that a plurality of plates 24 may be disposed between end faces of each two adjacent batteries 1.

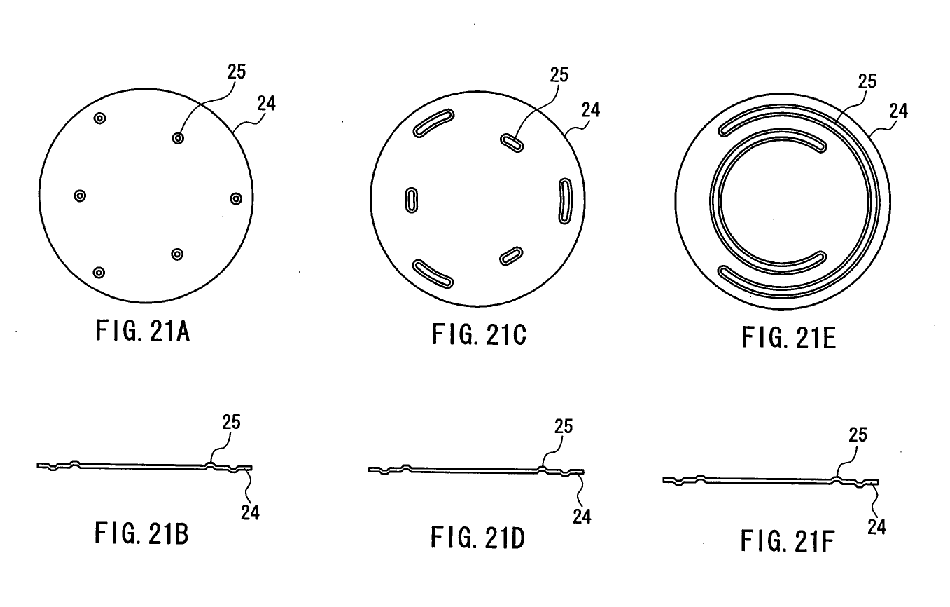

In the battery pack 21 shown in FIG. 20, projections may be formed on at least one principal surface of the plate 24. The reason for this is that electric connection between adjacent batteries 1 can be maintained more reliably with this configuration. When welding the plate 24 to the end face of the battery 1, the projections can serve as projections for use in projection welding. FIGS. 21A to 21F show examples of the plate 24 configured as above. In the plates 24 shown in FIGS. 21A to 21F, projections 25 are formed at least one principal surface thereof. FIG. 21B is a side view of the plate 24 shown in FIG. 21A, FIG. 21D is a side view of the plate 24 shown in FIG. 21C, and FIG. 21F is a side view of the plate 24 shown in FIG. 21E. In the case where the projections 14 are not formed on the end face of the battery 1, it is preferable that projections 25 are formed on both surfaces of the plate 24 in order to maintain electric connection between adjacent batteries 1 more reliably.

In the battery pack 21 shown in FIG. 20, the plate 24 may be welded to an end face of the battery 1. In the battery pack 21 configured as above, electric connection between adjacent batteries 1 can be maintained more reliably. Moreover, the strength of the battery pack 21 as a whole can be enhanced. The type of welding to be performed for connecting the end faces is not particularly limited, and may be, for instance, laser welding or the like. The above-described welding may be projection welding when projections are formed on the end face of the battery 1 and at least one principle surface of the plate 24.

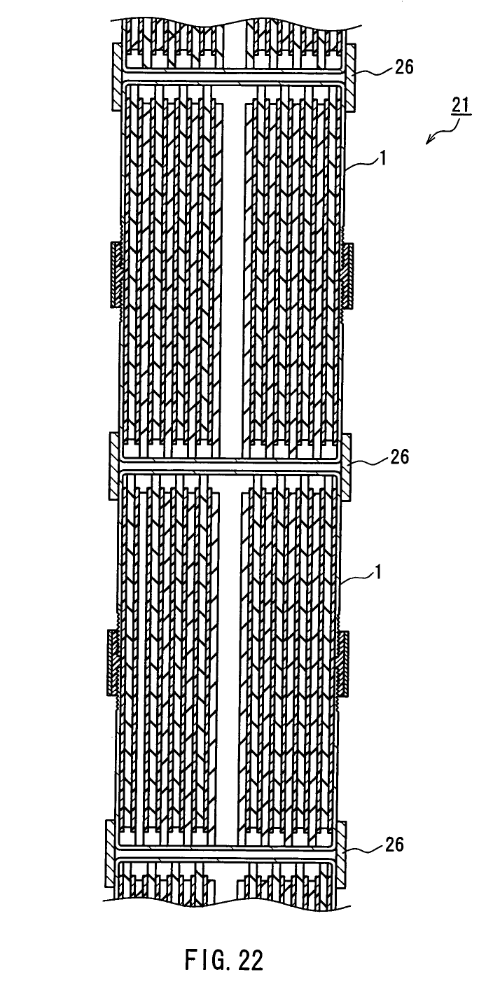

Still another example of a battery pack according to the present invention is shown in FIG. 22. In a battery pack 21 shown in FIG. 22, a conductive connection ring 26 further is provided for adjacent batteries 1, and the batteries 1 are connected in series via this connection ring 26. The connection ring 26 is disposed so as to be in contact with outer peripheral surfaces of portions near end faces of the respective adjacent batteries 1. With this configuration, the strength of the battery pack 21 as a whole can be enhanced. The connection ring 26 and the batteries 1 may be merely in contact with each other or may be welded to each other, for example. Although the end faces of the adjacent batteries 1 are not in direct contact with each other in the example shown in FIG. 22, they may abut against each other directly as in the example shown in FIG. 19. Furthermore, as in the example shown in FIG. 20, a conductive plate 24 may be disposed between the end faces of the adjacent batteries 1. In other words, in the examples shown in FIG. 19 and FIG. 20, the connection ring 26 further may be provided as in the example shown in FIG. 22. The material, structure, etc. of the connection ring 26 are not particularly limited as long as the connection ring 26 is conductive.

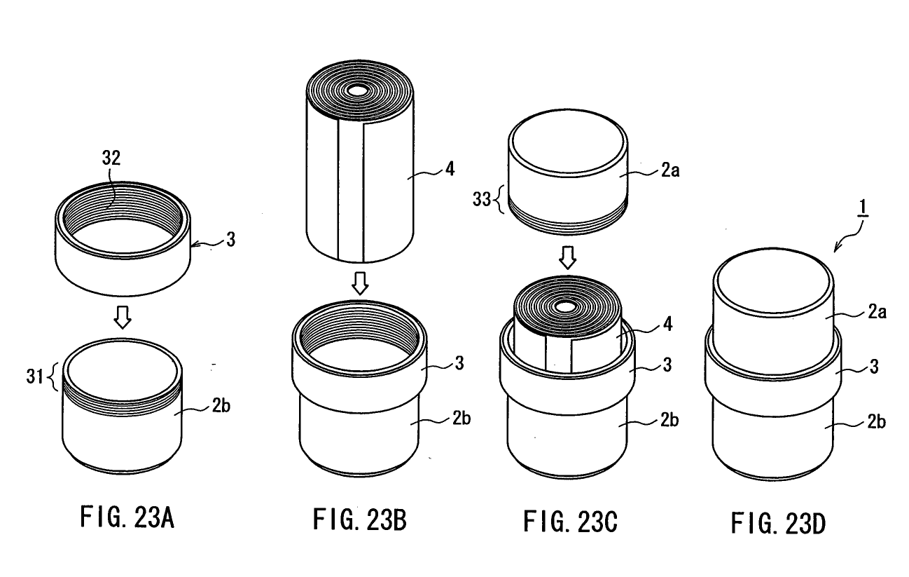

Next, a method for manufacturing a battery according to the present invention will be described with reference to the drawings. FIGS. 23A to 23D are views showing an example of a method for manufacturing a battery according to the present invention. First, as shown in FIG. 23A, a male thread portion 31 formed on an outer peripheral surface of the open end portion of a bottomed can 2b is threaded with a female thread portion 32 formed on an inner peripheral surface of a joint ring 3, so that the bottomed can 2b and the joint ring 3 are joined to each other (step (i)).

Next, as shown in FIG. 23B, an electrode plate group 4 including a pair of electrodes is placed in the bottomed can 2b (step (ii)).

Next, as shown in FIG. 23C, a male thread portion 33 formed on an outer peripheral surface of the open end portion of a bottomed can 2a is threaded with the female thread portion 32 of the joint ring 3 formed in a portion on a side opposite to the side joined to the bottomed can 2b. As a result, the bottomed can 2b and the bottomed can 2a are joined to each other via the joint ring 3 (step (iii)).

The battery 1 shown in FIG. 23D can be obtained by further performing, at any time, the step of electrically connecting the bottomed can 2b to the negative electrode included in the electrode plate group 4 (step (a)) and the step of electrically connecting the bottomed can 2a to the positive electrode included in the electrode plate group 4 (step (b)). Note here that the step (i) and the step (ii) may be performed in inverse order. Specific examples of the step (a) and the step (b) will be described later.

The bottomed cans 2a and 2b, the electrode plate group 4, and the joint ring 3 used in the manufacturing method of the present invention may be the same as the above-described bottomed cans, electrode plate group, and joint ring. For example, the electrode plate group 4 may include a separator and a positive electrode and a negative electrode that hold the separator therebetween, and may be wound.

In the step (i), the method of threading the bottomed can 2b with the joint ring 3 is not particularly limited. With regard to the degree of the threaded engagement to be achieved, note here that the threaded engagement may be achieved to the extent that the sealing of the battery 1 as a finished product can be maintained, for example. Moreover, the degree of the threaded engagement may be defined and controlled by the overall height of the battery 1 or the like, for example.

The method of placing the electrode plate group 4 in the step (ii) and the method of threading the bottomed can 2a with the joint ring 3 in the step (iii) are not particularly limited. In the case where it is necessary to place an electrolyte in addition to the electrode plate group 4 to compose a power generation component, the step of placing the electrolyte may be performed at any time. For example, when the electrolyte is solid, the electrode plate group 4 in which the electrolyte is inserted between the electrodes may be placed in the bottomed can 2b. When the electrolyte is liquid (i.e., an electrolytic solution), the electrolytic solution may be poured from a through hole that is formed beforehand in the bottom of the bottomed can 2a, for example, after performing the step (iii). The through hole may be sealed after the electrolytic solution has been poured.

The manufacturing method of the present invention may further include the step of: (c) disposing a current collector between the electrode plate group 4 and an interior of at least one bottomed can 2 selected from the bottomed can 2a and the bottomed can 2b. By disposing the current collector, electric connection between the interior of the bottomed can 2 and the electrode included in the electrode plate group 4 can be maintained more reliably. Thus, the battery 1 with excellent battery characteristics can be obtained. The current collector to be disposed may be the same as those described above. Furthermore, the inner region of the bottomed can 2 in which the current collector is to be disposed is not particularly limited. For example, as shown in FIG. 4, the current collector may be disposed on the bottom of the bottomed can 2.

The methods of performing the step (a) and the step (b) are not particularly limited. For example, these steps can be accomplished by placing the electrode plate group 4 or joining the pair of bottomed cans 2a and 2b to each other in such a manner that the positive electrode (the negative electrode) is in contact with the interior of the bottomed can 2a (2b). Note here that the above-described step (c) of disposing the current collector may be a part of the step (a) and/or the step (b).

It is only necessary that the step (a) and the step (b) are completed at the stage where the formation of the battery 1 is completed (at the stage of FIG. 23D in the example shown in FIG. 23). For example, even in the case where an intimate contact between the electrode plate group 4 and the bottomed can 2b has not yet been achieved before the step (iii), it is possible to achieve such an intimate contact at the same time, when threading the bottomed can 2a with the joint ring 3. Thus, it is not always necessary to maintain the contact between the negative electrode included in the electrode plate group 4 and the interior of the bottomed can 2b in the step (ii), but the contact between the negative electrode and the interior of the bottomed can 2b may be maintained by threaded engagement performed in the step (iii) (i.e., at the stage where the formation of the battery 1 is completed). The same applies with regard to the positive electrode and the bottomed can 2a. Also, the same applies to the specific examples (including the case where a current collector is disposed) of the step (a) and the step (b) described below.

Hereinafter, the step (a) and the step (b) in the manufacturing method of the present invention will be described more specifically. In the following description, the positive electrode and the negative electrode included in the electrode plate group 4 may be inverted.

For example, in the step (ii), the electrode plate group 4 may be placed in such a manner that the negative electrode included therein is in contact with the bottomed can 2b. This allows the negative electrode to be electrically connected to the bottomed can 2b. In this case, for example, when the negative electrode protrudes from one end face of the electrode plate group 4 as shown in FIG. 2, it is possible to achieve more reliable electric connection between the negative electrode and the bottomed can 2b. Thus, the internal resistance of the battery 1 can be decreased, and the reliability of the battery 1 can be improved.

Furthermore, the manufacturing method further may include the step of: (d) disposing a current collector in the bottomed can 2b, for example, before the step (ii), and in the step (ii), the electrode plate group 4 may be placed in such a manner that the current collector is in contact with the negative electrode included in the electrode plate group 4. According to such a manufacturing method, the negative electrode and the bottomed can 2b can be electrically connected to each other via the current collector. Furthermore, by disposing the current collector between the negative electrode and the bottomed can 2b, more reliable electric connection can be achieved.

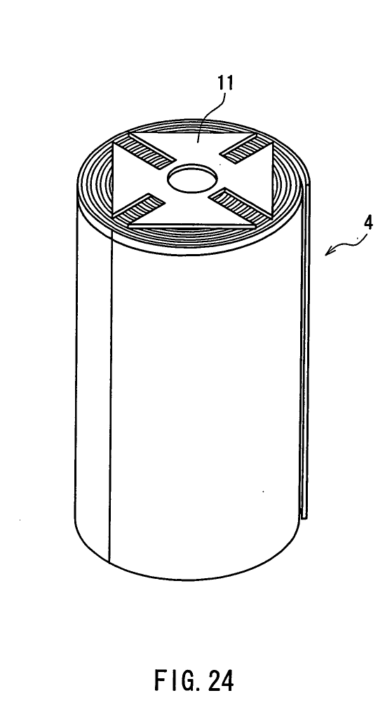

Furthermore, as shown in, e.g., FIG. 24, a current collector 11 may be disposed beforehand on one end of the electrode plate group 4 so as to be in contact with the negative electrode included the electrode plate group 4, and in the step (ii), the electrode plate group 4 may be placed in the bottomed can 2b in such a manner that the current collector 11 is in contact with the interior of the bottomed can 2b. According to such a manufacturing method, the negative electrode and the bottomed can 2b can be electrically connected to each other via the current collector 11. Moreover, by disposing the current collector 11 between the negative electrode and the bottomed can 2b, more reliable electric connection can be achieved.

In the foregoing specific examples, for example, in the step (iii), the bottomed can 2a and the bottomed can 2b may be joined to each other in such a manner that the positive electrode included in the electrode plate group 4 is in contact with the interior of the bottomed can 2a. This allows the positive electrode to be electrically connected to the bottomed can 2a. In this case, for example, when the positive electrode protrudes from the end face of the electrode plate group 4 on the bottomed can 2a side as shown in FIG. 2, it is possible to achieve more reliable electric connection between the positive electrode and the bottomed can 2a.

Furthermore, the manufacturing method further may include the step of: (e) disposing a current collector from an opening of the bottomed can 2b so as to be in contact with the positive electrode included in the electrode plate group 4, for example, between the step (ii) and the step (iii), and in the step (iii), the bottomed can 2a and the bottomed can 2b may be joined to each other in such a manner that the current collector disposed in the step (e) is in contact with the interior of the bottomed can 2a. According to such a manufacturing method, the positive electrode and the bottomed can 2a can be electrically connected to each other via the current collector.

Other than the above, the manufacturing method in which, for example, a first current collector is disposed beforehand on one end of the electrode plate group 4 so as to be in contact with the negative electrode included in the electrode plate group 4 and a second current collector is disposed beforehand on the other end of the electrode plate group 4 so as to be in contact with the positive electrode included in the electrode plate group 4 also is acceptable. In this case, in the step (ii), the electrode plate group 4 may be placed in the bottomed can 2b in such a manner that the first current collector that is in contact with the negative electrode is in contact with the interior of the bottomed can 2b, and in the step (iii), the bottomed can 2a and the bottomed can 2b may be joined to each other in such a manner that the second current collector that is in contact with the positive electrode is in contact with the interior of the bottomed can 2a. By so doing, the negative electrode and the bottomed can 2b can be electrically connected to each other via the first current collector, while the positive electrode and the bottomed can 2a can be electrically connected to each other via the second current collector.

In the manufacturing method of the present invention, at least one step selected from the step (a) and the step (b) may further include the step of (f) brazing the electrodes and the interiors of the bottomed cans 2. Alternatively, the above-described at least one step may include the step of: (g) welding the electrodes and the interiors of the bottomed cans 2. According to such a manufacturing method, it is possible to achieve more reliable electric connection between the electrodes included in the electrode plate group 4 and the interiors of the bottomed cans 2. The inner region of each bottomed can 2 to be subjected to the brazing or welding is not particularly limited, and may be, for example, the bottom of the bottomed can 2.

The step (f) and the step (g) may be performed at any time in the step (a) and the step (b). For example, the bottomed can 2b and bottomed can 2a may be joined to each other after the electrode plate group 4 has been placed in the bottomed can 2b and the negative electrode included in the electrode plate group 4 has been welded or brazed to the interior of the bottomed can 2b. Alternatively, the negative electrode included in the electrode plate group 4 may be welded or brazed to the interior of the bottomed can 2b after the electrode plate group 4 has been placed in the bottomed can 2b and the bottomed can 2b and the bottomed can 2a have been joined to each other. The same is applied with regard to the welding or brazing of the positive electrode to the interior of the bottomed can 2a. Note here that the step (f) and the step (g) may be performed with respect to both the pair of electrodes included in the electrode plate group 4 or either one of the electrodes.

In the step (f), the method of brazing the electrodes to the interiors of the bottomed cans 2 is not particularly limited, and any generally used method may be employed. Furthermore, in the step (g), the method of welding the electrodes to the interiors of the bottomed cans 2 is not particularly limited, and may be performed by, for instance, laser welding, resistance welding, or the like.

In the manufacturing method of the present invention, when a current collector is disposed between the electrode plate group 4 and the interior of at least one of the bottomed cans 2, at least one step selected from the step (a) and the step (b) may include the step of (h) brazing the current collector to the interior of the bottomed can 2 that holds the current collector between itself and the electrode plate group 4. Alternatively, the at least one step may include the step of: (j) welding the current collector to the interior of the bottomed can 2 that holds the current collector between itself and the electrode plate group 4. According to such a manufacturing method, it is possible to achieve reliable electric connection between the electrode included in the electrode plate group 4 and the interior of the bottomed can 2 via the current collector. The inner region of the bottomed can 2 to be subjected to the brazing or welding may be determined depending on the position where the current collector is disposed, and may be, for example, the bottom of the bottomed can 2.

Similarly to the step (f) and the step (g), the step (h) and the step (j) may be performed at any time in the step (a) and the step (b). In the case where the current collectors are disposed on both the positive electrode side and the negative electrode side, respectively, the step (h) and the step ( ) may be performed with respect to both the current collectors or either one of the current collectors.

In the step (h), the method of brazing the current collector to the interior of the bottomed can 2 is not particularly limited, and any generally used method may be employed. Furthermore, in the step (j), the method of welding the current collector to the interior of the bottomed can 2 is not particularly limited, and may be performed by, for instance, laser welding, resistance welding, or the like.

In the manufacturing method of the present invention, the winding direction of the electrode plate group 4 to be placed in the bottomed can 2b in the step (ii) may be the same as the rotating direction of the bottomed can 2a rotated in the step (iii). According to such a manufacturing method, it is possible to reduce the occurrence of an internal short circuit in the battery 1. During the manufacture of the battery 1, the possibility that an outermost layer of the electrode plate group 4 may be everted partially by the rotation of the bottomed can 2a cannot be denied completely. Regardless of whether the layer is an electrode or a separator, there is a possibility that the everted (or exposed) electrode resulting from the eversion of the outermost layer may be in contact with the bottomed can 2a. However, by setting the winding direction of the electrode plate group 4 to be the same as the rotating direction of the bottomed can 2a, it is possible to reduce the possibility that the layer may be everted. That is, it is possible to obtain a more reliable battery 1 in which the occurrence of an internal short circuit is reduced.

In the manufacturing method of the present invention, an electrode located at the outermost periphery of the electrode plate group 4 to be placed in the bottomed can 2b in the step (i) may be an electrode to be electrically connected to the bottomed can 2a in the step (b). According to such a manufacturing method, it is also possible to reduce the occurrence of an internal short circuit in the battery 1. As described above, during the manufacture of the battery 1, there is a possibility that an outermost layer of the electrode plate group 4 may be everted partially by the rotation of the bottomed can 2a so that the everted (or exposed) electrode may be in contact with the bottomed can 2a. In this case, however, by setting the everted (or exposed) electrode, i.e., the electrode located at the outermost periphery of the electrode plate group 4, to have the same polarity as the bottomed can 2a, it is possible to reduce the occurrence of an internal short circuit. It order to set the polarity of the electrode to be the same as that of the bottomed can 2a, the electrode located at the outermost periphery of the electrode plate group 4 may be set to be the electrode to be electrically connected to the bottomed can 2a. Note here that the electrode located at the outermost periphery of the electrode plate group 4 refers to an electrode that is located at the outermost periphery without giving consideration to the components (such as the separator) other than the electrodes. Thus, the electrode located at the outermost periphery is not necessarily the above-described outermost layer.

In the manufacturing method of the present invention, the outermost periphery of the electrode plate group 4 to be placed in the bottomed can 2b in the step (ii) may be the separator. According to such a manufacturing method, the possibility of an internal short circuit in the battery 1 can be reduced, thereby allowing a more reliable battery 1 to be obtained.

Furthermore, in the manufacturing method of the present invention, a peripheral surface of the joint ring 3 and a peripheral surface of an open end portion of each of the bottomed cans 2a and 2b may be formed in predetermined shapes. In such a manufacturing method, the step (i) may be a step for joining the bottomed can 2b and the joint ring 3 by engaging the open end portion of the bottomed can 2b with the joint ring 3, and the step (iii) may be a step for joining the bottomed can 2b and the bottomed can 2a to each other via the joint ring 3 by engaging the open end portion of the bottomed can 2a with the portion of the joint ring 3 on the side opposite to the side joined to the bottomed can 2b. According to such a manufacturing method, the battery 1 of the present invention in which the pair of bottomed cans 2a and 2b are joined to each other by being engaged with the joint ring 3 as shown in FIG. 14 can be obtained. In the foregoing manufacturing method, the method of disposing the current collector, the method of electrically connecting the bottomed can 2 to the electrode or the current collector, and the like may be the same as those described above. Also, the structure of the electrode plate group 4 and the like may be the same as those described above.

In the above-described manufacturing method, the method of engaging the joint ring 3 and the bottomed cans 2a and 2b with each other is not particularly limited. For example, the shape of the peripheral surface of the joint ring 3 and the shape of the peripheral surface of the open end portion of each of the bottomed cans 2a and 2b may be set beforehand so as to engage with each other. Alternatively, the open end portion of the bottomed can 2a or the bottomed can 2b may be engaged with the joint ring 3 by contracting the diameter of the bottomed can 2a or the bottomed can 2b. Although the bottomed can whose diameter is to be contracted may be either the bottomed can 2a or the bottomed can 2b, it preferably is the bottomed can that is engaged with the joint ring 3 in the step (iii) (the bottomed can 2a in the example shown in FIG. 23C).

Next, an example of a method for manufacturing a battery pack according to the present invention will be described mainly with reference to FIG. 18.

The manufacturing method of a battery pack according to the present invention includes the steps of: (x) disposing a plurality of batteries 1 so that end faces of adjacent batteries abut against each other; and (y) connecting the adjacent batteries in series by electrically connecting the end faces to each other.

In the step (x), the method of disposing the plurality of batteries 1 so that end faces of adjacent batteries 1 abut against each other is not particularly limited. Also, the number or the like of batteries 1 to be disposed may be set arbitrarily.

In the step (y), the method of electrically connecting the end faces of the adjacent batteries 1 to each other is not particularly limited. For example, the end faces of the adjacent batteries 1 may be electrically connected to each other by welding the end faces to each other.

Furthermore, in the manufacturing method of the present invention, in the step (x), a conductive plate 24 (see FIG. 20) further may be provided between the end faces of the adjacent batteries 1 so that the end faces abut against each other via the plate 24, and in the step (y), the end faces may be electrically connected to each other by welding the end face of one of the adjacent batteries 1 that abut against each other via the plate 24 to one principal surface of the plate 24 and the end face of the other battery 1 to the other principal surface of the plate 24.

In the step (y), the method of welding is not particularly limited, and may be performed by laser welding, for example. In the case where projections are formed on an end face of the battery 1 and/or a principal surface of the plate 24, projection welding may be used.

According to the present invention, a battery and a battery pack that can achieve high energy density and excellent output characteristics can be provided, for example. The battery and the battery pack of the present invention are applicable to various primary and secondary batteries, such as an alkaline-manganese battery, a nickel-cadmium battery, a nickel-metal hydride battery, and a lithium-ion battery, for example.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A battery comprising:
a pair of cylindrical bottomed cans;
a joint ring for joining an open end portion of one of the bottomed cans to an open end portion of the other bottomed can; and
a power generation component comprising a pair of electrodes, the power generation component being accommodated in the joined bottomed cans,
wherein one of the bottomed cans is electrically connected to one of the electrodes,
the other bottomed can is electrically connected to the other electrode, and
a region of the joint ring that is in contact with one of the bottomed cans is electrically insulated from a region of the joint ring that is in contact with the other bottomed can.

2. The battery according to claim 1, wherein a thread portion is formed on a peripheral surface of the joint ring and a thread portion is formed on a peripheral surface of the open end portion of each of the bottomed cans, and
the pair of bottomed cans are joined to each other via the joint ring when the thread portions of the respective bottomed cans and the thread portion of the joint ring are threaded with each other.

3. The battery according to claim 1, wherein the power generation component comprises an electrolyte and an electrode plate group comprising a separator and a positive electrode and a negative electrode that hold the separator therebetween, and
the electrode plate group is wound.

4. The battery according to claim 2, wherein a female thread portion is formed on an inner peripheral surface of the joint ring,
a male thread portion is formed on an outer peripheral surface of the open end portion of each of the bottomed cans, and
the pair of bottomed cans are joined to each other via the joint ring by threading the male thread portions of the respective bottomed cans with the female thread portion of the joint ring.

5. The battery according to claim 1, wherein the electrode is electrically connected to a bottom of the bottomed can.

6. The battery according to claim 5, wherein the electrode is electrically connected to a bottom of the bottomed can by at least one selected from welding and brazing.

7. The battery according to claim 1, further comprising a current collector disposed between the electrode and the bottom of the bottomed can,
wherein the electrode is electrically connected to the current collector, and the current collector is electrically connected to the bottom of the bottomed can.

8. The battery according to claim 7, wherein the current collector is electrically connected to the bottom of the bottomed can by at least one selected from welding and brazing.

9. The battery according to claim 7, wherein the current collector is at least one current collector selected from a burring current collector and a disc spring-type current collector.

10. The battery according to claim 1, wherein the pair of bottomed cans differ from each other in depth.

11. The battery according to claim 1, wherein a through hole is formed on a bottom of at least one of the bottomed cans, and
the through hole is sealed.

12. The battery according to claim 11, wherein the through hole is sealed by at least one selected from a thin film and a lid that comprises a safety valve.

13. The battery according to claim 1, wherein a through hole is formed in the joint ring, and
the through hole is sealed.

14. The battery according to claim 13, wherein the through hole is sealed by at least one selected from a thin film and a lid that comprises a safety valve.

15. The battery according to claim 1, wherein the regions of the joint ring that are in contact with the pair of bottomed cans are made of resin.

16. The battery according to claim 15, wherein the joint ring is made of resin.

17. The battery according to claim 1, wherein the joint ring comprises a metal layer and a resin layer, and
the region of the joint ring that is in contact with one of the bottomed cans is electrically insulated from the region of the joint ring that is in contact with the other bottomed can by the resin layer.

18. The battery according to claim 1, wherein the joint ring has an annular contact portion, and
open ends of the pair of bottomed cans abut against each other via the contact portion.

19. The battery according to claim 18, further comprising a sealing member disposed between the contact portion and the open end of at least one of the pair of bottomed cans,
wherein the open ends of the pair of bottomed cans abut against each other via the contact portion and the sealing member.

20. The battery according to claim 19, wherein the sealing member is made of an elastic body and is present in a state where the sealing member is compressed.

21. The battery according to claim 2, wherein the thread portion of the joint ring and the thread portion of the bottomed can are taper threads.

22. The battery according to claim 3, wherein an outermost periphery of the electrode plate group is the separator.

23. The battery according to claim 3, wherein the electrode plate group is covered with an electrically insulating material.

24. The battery according to claim 1, wherein at least one selected from a projection and a recess is formed on an outer surface of a bottom of at least one of the bottomed cans.

25. The battery according to claim 1, wherein an outer shape of the joint ring is formed in a polygonal shape.

26. The battery according to claim 1, wherein the pair of bottomed cans are joined to each other via the joint ring by engaging the joint ring and the open end portions of the bottomed can with each other.

27. The battery according to claim 26, wherein a strip for applying force toward an internal circumference of the joint ring further is disposed on an outer peripheral surface of the joint ring.

28. The battery according to claim 26, wherein a diameter of at least one of the bottomed cans is contracted.

29. A battery pack comprising a plurality of the batteries according to claim 1, wherein the batteries are connected in series.

30. The battery pack according to claim 29, wherein the batteries are connected in series by disposing the batteries so that end faces of adjacent batteries abut against each other.

31. The battery pack according to claim 30, wherein the end faces of the adjacent batteries are welded to each other.

32. The battery pack according to claim 29, wherein a projection is formed on an end face of the battery, and
the adjacent batteries are connected in series via the projection.

33. The battery pack according to claim 29, further comprising a conductive plate disposed between the end faces of the adjacent batteries,
wherein the adjacent batteries are connected in series via the plate.

34. The battery pack according to claim 33, wherein a projection is formed on at least one principal surface of the plate.

35. The battery pack according to claim 33, wherein the end faces and the plate are welded to each other.

36. A method for manufacturing a battery comprising the steps of:
(i) joining a joint ring to an open end portion of a first bottomed can;
(ii) placing an electrode plate group comprising a pair of electrodes in the first bottomed can; and
(iii) joining an open end portion of a second bottomed can to a portion of the joint ring on a side opposite to a side joined to the first bottomed can, so that the first bottomed can and the second bottomed can are joined to each other via the joint ring,
wherein the method further comprises the steps of:
(a) electrically connecting the first bottomed can to one of the electrodes; and
(b) electrically connecting the second bottomed can to the other electrode.

37. The method according to claim 36, wherein the step (i) is a step for joining the first bottomed can and the joint ring to each other by threading a male thread portion formed on an outer peripheral surface of the open end portion of the first bottomed can with a female thread portion formed on an inner peripheral surface of the joint ring, and
the step (iii) is a step for joining the first bottomed can and the second bottomed can to each other via the joint ring by threading a male thread portion formed on an outer peripheral surface of the open end portion of the second bottomed can with the female thread portion of the joint ring formed in a portion on the side opposite to the side joined to the first bottomed can.

38. The method according to claim 36, wherein the electrode plate group comprises a separator and a positive electrode and a negative electrode that hold the separator therebetween, and the electrode plate group is wound

39. The method according to claim 38, wherein an outermost periphery of the electrode plate group is the separator.

40. The method according to claim 36, further comprising the step of:
(c) disposing a current collector between the electrode plate group and an interior of at least one bottomed can selected from the first bottomed can and the second bottomed can.

41. The method according to claim 36, wherein in the step (ii), the electrode plate group is placed in such a manner that one of the electrodes comprised in the electrode plate group is in contact with the interior of the first bottomed can.

42. The method according to claim 36, further comprising the following step (d) before the step (ii),
(d) disposing a current collector in the first bottomed can,
wherein in the step (ii), the electrode plate group is placed in such a manner that the current collector is in contact with one of the electrodes comprised in the electrode plate group.

43. The method according to claim 36, wherein a current collector is disposed beforehand on one end of the electrode plate group so as to be in contact with one of the electrodes comprised in the electrode plate group, and
in the step (ii), the electrode plate group is placed in such a manner that the current collector is in contact with an interior of the first bottomed can.

44. The method according to claim 36, wherein a first current collector is disposed beforehand on one end of the electrode plate group so as to be in contact with one of the electrodes comprised in the electrode plate group,
a second current collector is disposed beforehand on the other end of the electrode plate group so as to be in contact with the other electrode comprised in the electrode plate group,
in the step (ii), the electrode plate group is placed in the first bottomed can in such a manner that the first current collector is in contact with an interior of the first bottomed can, and
in the step (iii), the first bottomed can and the second bottomed can are joined to each other in such a manner that the second current collector is in contact with an interior of the second bottomed can.

45. The method according to claim 36, wherein in the step (iii), the first bottomed can and the second bottomed can are joined to each other in such a manner that the other electrode comprised in the electrode plate group is in contact with an interior of the second bottomed can.

46. The method according to claim 36, further comprising the following step (e) between the step (ii) and the step (iii),
(e) disposing a current collector from an opening of the first bottomed can so as to be in contact with the other electrode comprised in the electrode plate group,
wherein in the step (iii), the first bottomed can and the second bottomed can are joined to each other in such a manner that the current collector is in contact with an interior of the second bottomed can.

47. The method according to claim 36, wherein at least one step selected from the step (a) and the step (b) further comprises the step of:
(f) brazing the electrode and an interior of the bottomed can.

48. The method according to claim 36, wherein at least one step selected from the step (a) and the step (b) further comprises the step of:
(g) welding the electrode and an interior of the bottomed can.

49. The method according to claim 48, wherein the step (g) is performed by at least one selected from laser welding and resistance welding.

50. The method according to claim 36, further comprising the step of:
(c) disposing a current collector between the electrode plate group and an interior of at least one bottomed can selected from the first bottomed can and the second bottomed can,
wherein at least one step selected from the step (a) and the step (b) comprises the step of:
(h) brazing the current collector to the interior of the bottomed can that holds the current collector between itself and the electrode plate group.

51. The method according to claim 36, further comprising the step of:
(c) disposing a current collector between the electrode plate group and an interior of at least one bottomed can selected from the first bottomed can and the second bottomed can,
at least one step selected from the step (a) and the step (b) comprises the step of:
(j) welding the current collector to the interior of the bottomed can that holds the current collector between itself and the electrode plate group.

52. The method according to claim 51, wherein the step (j) is performed by at least one selected from laser welding and resistance welding.

53. The method according to claim 36, wherein the step (i) is a step for joining the first bottomed can and the joint ring to each other by threading a male thread portion formed on an outer peripheral surface of the open end portion of the first bottomed can with a female thread portion formed on an inner peripheral surface of the joint ring,
the electrode plate group placed in the first bottomed can in the step (ii) comprises a separator and a positive electrode and a negative electrode that hold the separator therebetween the separator, and the electrode plate group is wound,
the step (iii) is a step for joining the first bottomed can and the second bottomed can to each other via the joint ring by threading a male thread portion formed on an outer peripheral surface of the open end portion of the second bottomed can with the female thread portion of the joint ring formed in a portion on the side opposite to the side joined to the first bottomed can, and
a winding direction of the electrode plate group placed in the first bottomed can in the step (ii) is the same as a rotating direction of the second bottomed can rotated in the step (iii).

54. The method according to claim 36, wherein the step (i) is a step for joining the first bottomed can and the joint ring to each other by threading a male thread portion formed on an outer peripheral surface of the open end portion of the first bottomed can with a female thread portion formed on an inner peripheral surface of the joint ring,
the electrode plate group placed in the first bottomed can in the step (ii) comprises a separator and a positive electrode and a negative electrode that hold the separator therebetween the separator, and the electrode plate group is wound,
the step (iii) is a step for joining the first bottomed can and the second bottomed can to each other via the joint ring by threading a male thread portion formed on an outer peripheral surface of the open end portion of the second bottomed can with the female thread portion of the joint ring formed in a portion on the side opposite to the side joined to the first bottomed can, and
an electrode located at an outermost periphery of the electrode plate group placed in the first bottomed can in the step (ii) is the other electrode electrically connected to the second bottomed can in the step (b).

55. The method according to claim 36, wherein the step (i) is a step for joining the first bottomed can and the joint ring to each other by engaging the open end portion of the first bottomed can with the joint ring, and
the step (iii) is a step for joining the first bottomed can and the second bottomed can to each other via the joint ring by engaging the open end portion of the second bottomed can with the portion of the joint ring on the side opposite to the side joined to the first bottomed can.

56. The method according to claim 55, wherein the open end portion of the second bottomed is engaged with the joint ring by contracting a diameter of the second bottomed can.

57. A method for manufacturing a battery pack in which a plurality of batteries are connected in series, comprising the steps of:
(x) disposing the plurality of batteries so that end faces of adjacent batteries abut against each other; and
(y) connecting the adjacent batteries in series by electrically connecting the end faces to each other,
wherein said batteries are the batteries according to claim 1.

58. The method according to claim 57, wherein in the step (y), the end faces of the adjacent batteries are electrically connected to each other by welding the end faces to each other.

59. The method according to claim 57, wherein in the step (x), a conductive plate is disposed between the end faces of the adjacent batteries so that the end faces of the adjacent batteries abut against each other via the plate, and
in the step (y), the end faces are electrically connected to each other by welding the end face of one of the adjacent batteries that abut against each other via the plate to one principal surface of the plate and the end face of the other battery to the other principal surface of the plate.
